(19) United States
(12) Patent Application Publication
(10) Pub. No.: US 2025/0097303 A1
(43) Pub. Date: Mar. 20, 2025

(54) CHIRP NETWORKS

(71) Applicant: Francis daCosta, Santa Clara, CA (US)

(72) Inventor: Francis daCosta, Santa Clara, CA (US)

(21) Appl. No.: 18/970,636

(22) Filed: Dec. 5, 2024

Related U.S. Application Data
(63) Continuation-in-part of application No. 17/844,682, filed on Jun. 20, 2022.
Application No. 17/844,682 is a continuation of application No. 17/027,381, filed on Sep. 21, 2020, now Pat. No. 11,368,537.
Application No. 17/027,381 is a continuation-in-part of application No. 15/908,108, filed on Feb. 28, 2018, now Pat. No. 10,785,316.
Application No. 15/908,108 is a continuation-in-part of application No. 15/728,863, filed on Oct. 10, 2017, now abandoned.
Application No. 15/728,863 is a continuation of application No. 14/740,062, filed on Jun. 15, 2015, now Pat. No. 9,819,747.
Application No. 14/740,062 is a continuation-in-part of application No. 13/571,294, filed on Aug. 9, 2012, now Pat. No. 9,172,738.
Application No. 13/571,294 is a continuation of application No. 14/523,778, filed on Oct. 24, 2014, now Pat. No. 9,730,100.
(60) Provisional application No. 63/606,985, filed on Dec. 6, 2023.

(51) Int. Cl. H04L 67/145; H04L 12/46; H04L 45/02; H04L 45/48; H04L 49/00; H04W 4/14; H04W 4/70; H04W 28/06; H04W 40/24; H04W 84/18

(52) U.S. Cl. CPC H04L 67/145; H04L 12/4625; H04L 45/02; H04L 45/48; H04L 49/70; H04W 4/14; H04W 28/065; H04W 40/248; H04W 4/70; H04W 84/18

(57) ABSTRACT

A system and method for orchestrating chirp-based communication in a distributed network is described. It includes configuring edge devices with imprinted chirp patterns, channels, and schedules derived from an orchestration source. The system and method also include segmenting collision domains in time, frequency, and spatial dimensions to ensure efficient and equitable use of shared communication resources. The system and method use propagator nodes to aggregate, filter, and forward chirp messages to cloud systems while preserving cryptic and minimalistic payloads and adjusts timing dynamically based on network conditions, application relevance windows, and power constraints.

This application claims priority as a non-provisional of U.S. application 63/606,985, filed on Dec. 6, 2023, presently pending. This application also claims priority as a continuation in part of U.S. application Ser. No. 17/844,682, filed on Jun. 20, 2022, presently pending, which also claimed priority as a continuation of a continuation of 17/027,381, filed on Sep. 21, 2020, presently issued as U.S. Pat. No. 11,368,537, which in turn was a continuation in part of Ser. No. 15/908,108 filed on Feb. 28, 2018, issued as U.S. Pat. No. 10,785,316, which is a continuation in part of Ser. No. 15/728,863, filed on Oct. 10, 2017, presently abandoned, which was a continuation of Ser. No. 14/740,062 filed on Jun. 15, 2015, issued as U.S. Pat. No. 9,172,738, and was in turn a continuation in part of U.S. application Ser. No. 14/523,778 filed on Oct. 24, 2014, issued as U.S. U.S. Pat. No. 9,730,100. application Ser. No. 14/740,062 was also a continuation in part of U.S. application Ser. No. 13/764,008 filed on Feb. 11, 2013, issued as U.S. Pat. No. 9,363,651 on Jun. 7, 2016. The contents of each application are hereby incorporated by reference.

### FIELD OF THE INVENTION

This invention relates to the field of computer networks and machine communications and, more particularly to a network system and method for facilitating large scale messaging.

Further, this invention leverages Global level intermittent connectivity using IP backbones for all but the first few hops from edge devices sending terse messages (“chirps”) to cloud services for IoT and Industrial IoT (IIoT). In at least one embodiment, the invention enables Global level logistics for IoT Edge data to reach cloud services within the time window of relevance. Such transmissions mandated a new approach to edge→cloud connectivity where globally ubiquitous minimally intermittently connectivity suffices. The Edge→Propagator→Cloud chain addresses key challenges which limit the deployment of IoT on a massive scale.

The future world of small, dumb, cheap, and copious sensors, actuators, and devices demands rethinking at both ends of the scale. At the far reaches of the network, simplified chirps will minimize lifetime costs for the myriad end points of the Internet of Things. At the same time, powerful networking and applications tools concentrated in intermediate network devices (propagator devices) will allow unprecedented control and flexibility in creating huge enterprise networks of diverse elements by extending industry-standard Software Defined Networking capabilities. Fully exploiting the power of the Internet of Things will grow from a total rethinking of network architectures

### BACKGROUND OF THE INVENTION

Over the next decade, most devices connected to the Internet or other global network will not be used by people in the familiar way that personal computers, tablets and smart phones are. Billions of interconnected devices will be monitoring the environment, structures, transportation systems, factories, farms, forests, utilities, soil and weather conditions, oceans and resources. Many of these sensors and actuators will be networked into autonomous sets, with much of the information being exchanged machine-to-machine directly and without human involvement Machine-to-machine communications are typically terse. Most sensors and actuators will report or act upon small pieces of information—“chirps.” Burdening these devices with current network protocol stacks is inefficient, unnecessary and unduly increases their cost of ownership. The architecture of the Internet of Things necessarily entails a widely distributed topology incorporating simpler chirp protocols towards at the edges of the network. Intermediate network elements perform information propagation, manage broadcasts, and provide protocol translation. Another class of devices house integrator functions providing higher-level analysis, for both near-edge analytics and broader-scope analysis. Small chirp data will feed “big data” systems. The propagation of pollen and the interaction of social insects are relevant to the emerging architecture of the Internet of Things described in the instant application. Pollen is lightweight by Nature, to improve its reach. It is inherently secure, only the receiver can decode its message. Nature's design is very different from today's traditional large packet and sender-oriented network traffic.

This application describes a rethink of current approaches to the Internet of Things. Appropriate architectures are described that will coexist with existing incumbent networking protocols. An architecture comprised of integrator functions, propagator nodes, and end devices, along with their interactions, is explored. Example applications are used to illustrate concepts and draw on lessons learned from Nature.

### SUMMARY OF THE INVENTION

A scalable, extensible, innately secure network architecture and protocol is suggested, where simple devices speak simply under supervision from the cloud and their trusted applications on minimally intermittently connected devices and networks. Schedules, RF channels and chirp patterns are remotely managed from the cloud, leveraging minimal cost edge imprint-able devices.

These devices leverage Globally Ubiquitous intermittent connectivity using IP backbones for all but the first hops from “Chirp” Edge child devices to existing Cloud “Mother” processing services for IIoT. Segmenting the shared collision domains in time (scheduling) wireless (channels and patterns) has been extensively taught per references. This application enlarges on embodiments.

It thus revisits methods taught earlier for Edge→Cloud mandating low power, stealthy, terse messaging, disruption tolerance, dynamic channel and time management using app-to-app status heart beats along with other terse messages, and over unreliable, minimally intermittent, spotty and un-trustworthy networks. These methods teach a new approach to Edge→Cloud connectivity as Edge→Propagator→Cloud. Further, the methods taught relate to. Outdoor Remote hostile harsh environments including applications in forestry, rural agriculture, ocean and pollution monitoring, and other use case conditions. In many situations, current wireless connectivity is not scalable or sustainable at a global scale. Taking cues from Nature and Nature's receiver-oriented broadcast approach:

1. The Iot M2m data is terse and innately secure in a receiver-oriented messaging system—like Pollen, as described in FIGS. 7 and 8. Small packets→less power and secure: detection harder.

2. In Nature, chirps have chirp-listen-repeat-or-stop messaging that is species based. Birdcalls are both private and public. Broadcasts are simple—like wireless serial modems—and heard by all on that channel and time.

Nonetheless, the terse messages are distinguishable, discoverable and undecipherable for all but by the intended—in receiver-oriented messaging.

3. This system is zero-trust (through imprinting at birth) and minimal. Thus edge device firmware may be minimal—ant-like, like a deterministic finite automaton, and reusable/teachable.

4. The communication protocol and implementing hardware are thus minimal and may be cloud orchestrated using existing propagators like cars, phones, drones that are increasingly ubiquitous. It is reprogrammable and may be embedded in physical assets to engender zero-trust, Enterprise class pub/sub messaging.

5. A logical friend-to-friend network of imprinted devices may opt-in to share insights and tracking across walled garden boundaries—emergence, “co-operation of things of unlike kinds”—with cloud orchestrated software defined networking tools servicing them. Such networks can be sustainably global scale because all the power hungry computing is at the cloud end making the edge both low power and innately secure—two major challenges impeding Massive IoT, FIG. 52.

6. In summary this application teaches embodiments, salient to this conjecture:

Global Scale Logistics is driven by what SCADA solution elements provide.

Global SCADA increasingly needs low power trusted Edge connectivity.

Ubiquitous intermittent connectivity is the lowest common denominator. Serial Modem like (non MAC) broadcast protocol is ubiquitously supported.

Imprinted, receiver-oriented messaging, is zero-trust and lightweight.

Small, Dumb, Cheap Copious is sustainable low power, secure Edge→Cloud.

### CROSS REFERENCES

The following references are herein incorporated by reference.

1. Managing Jitter and Latency in Wireless LANs VOIP emulating Terse periodic messaging https://docs.google.com/viewer?url=patentimages.storage.googleapis.com/pdfs/US7583,648.pdf

2. Self-Forming VOIP Networks Baseline local autonomy using a SIP like registry https://docs.google.com/viewer?url=patentimages.storage.googleapis.com/pdfs/US7,583,648.pdf

3. Real-time packet transforms to avoid re-transmissions https://docs.google.com/viewer?url=patentimages.storage.googleapis.com/pdfs/US7,583,648.pdf

4. Collaborative logistics ecosystem packets scheduling to avoid “stacking” https://docs.google.com/viewer?url=patentimages.storage.googleapis.com/pdfs/US7583,648.pdf

5. Chirp Networks Seminal work on co-existence and scalable pub/sub https://docs.google.com/viewer?url=patentimages.storage.googleapis.com/pdfs/US7583,648.pdf

6. Terse Message Networks Implementation related extensions https://docs.google.com/viewer?url=patentimages.storage.googleapis.com/pdfs/US7583,648.pdf

7. Chirp Networks Implementation related extensions https://docs.google.com/viewer?url=patentimages.storage.googleapis.com/pdfs/US7583,648.pdf

8. Evolutionary Wireless Networks Rapid re-routing in propagator networks. https://docs.google.com/viewer?url=patentimages.storage.googleapis.com/pdfs/US7583,648.pdf

9. Rethinking the Internet of Things, Springer-Verlag 2013

https://meshdynamics.com/documents/Rethinking-Internet-Of-Things-Book.pdf

10. It's Different Out There, blog entries 2012-2013 .

https://meshdynamics.com/documents/Rethinking-Internet-Of-Things-Book.pdf

### DETAILED DESCRIPTION OF SPECIFIC EMBODIMENTS

The description above and below and the drawings of the present document focus on one or more currently embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention. Section titles are terse and are for convenience only.

### The Rationale Behind “Small Dumb Cheap Copious”

Many enterprises that rely on industrial devices such as sensors, conveyor belts, farming equipment, medical equipment and pumps—particularly, globally distributed ones—are struggling to monitor and manage those devices for several reasons:

Operational cost and complexity: The overhead of managing the deployment, maintenance and upgrades for exponentially more devices is stifling. And even with a custom solution in place, the resource investments required for necessary IT infrastructure are significant.

Patchwork security: Ensuring world-class, end-to-end security for globally distributed devices is out of reach—or at least not a core competency—for most organizations.

Data fragmentation: Despite the fact that machine-generated data is now an important data source for making good business decisions, the massive amount of data generated by these devices is often stored in silos with a short expiration date, and hence never reaches downstream analytic systems (nor decision makers).

Chirp Protocols and Dynamically Scheduled and reprogrammable sensor streams resolve these problems by removing risk, complexity and data silos from the device monitoring and management process. Instead, it offers Global Scale Enterprises, Governments and regulatory agencies (WHO, NATO, UN) the ability to more securely connect and manage all trusted edge devices as a single global system with enterprise class Pub-Sub Messaging at all levels of the data supply chain. Enterprise IoT Control Systems, operating at multiple levels, can ingest data generated by all those devices into a responsive data pipeline—and, when combined with other Cloud IoT services, analyze and react to that data in real time.

Taking cues from Nature, chirps are terse, intentionally cryptic, periodic messages, broadcast over shared, lossy, public medium. The packet contains minimally a Chirp-ID—for topic based addressing and a payload. The Chirp-ID is sufficiently distinguishable to get the packet to IP backbone and forward it to subscribers. The forwarding begins with another smarter element in the messaging supply chain, the propagator software that tags the packet with time/location etc. Like pollen, payload is undecipherable to all but intended receivers. It may use a digital DNA like RYGB (Red, Yellow, Green, Black), to describe a time series streams of threshold transitions, driving building automation control systems. Thus the packet is Distinguishable (Chirp-ID) and undecipherable (Payload is cryptic). It is also imprinted at birth (described later) to ensure end-to-end encryption. The protocol—chirp patterns, schedules, and frequencies—whatever is best suited to Enterprise Product/Market fits—is firmware and implementation abstracted. It can run on any wireless connected device (phones, drones, networks). Ant-like logic resides in silicon, kernel space, user space, fog, cloud. It uses “dumb” wireless modems—minimal “cheap”. The units are Small Dumb Cheap Copious.

### Implementation Details

Chirp devices and networks are neither Machine-to-Machine (M2M) nor periodic connectivity solutions marketed as low power IoT. Differences include:
Minimal power consumption for first hops edge→cloud devices. FIG. 13-17.
Internet connectivity may be intermittent, spotty and sparse FIG. 38-40.
The first link of multi-hop from (edge) device to cloud (core) may be distinct in protocol from other hops on an IP backbone, FIG. 1, 13.
The low power edge devices may be remote and un-connected, FIG. 38-40.
The framework may scale to millions of connected devices, FIG. 23.
The framework may coexist with existing radio protocols, FIG. 21-22.
The packet structure is innately secure—no encryption needed FIG. 16-17.
The packet may be self-classified—No MAC-ID, UUID needed. FIG. 16-17.
The framework supports public, private and stealth messaging, FIG. 25-27.
At each hop of the network there may be progressive refining, FIG. 18-20.
Packet arrival is timely, in time window of relevance for control systems.
The framework can separate data collection from delivery schedule, FIG. 1.
The framework may manage both low level and supervisory control, FIG. 28.
The framework may direct edge behavior from cloud agents, FIG. 32-35.

The figures provide example implementations including: Wireless (IR, Sonic, Radio) minimally Intermittent connection for low power—but secure—devices calls for thin devices and thin connectivity (sparse, perhaps unpredictable) receiver-oriented messaging FIG. 7-9. Low power usage and to avoid detection, drives terse messaging and thus terse topic based addressing, (self-classifying) schemes, are scalable, FIG. 16-21, resilient FIG. 24-27.

After the power constrained first hops—from the device to carrier pigeon (propagator)—the data is on powered IP backbones that move large packets and can afford heavy encryption. Current “low power” wire-less connectivity at the edge is low power in name only. Bluetooth Low Energy (BLE), Zigbee, Zwave, 6LowPAN, Z-Wave, SigFox, NWave, Ingenu etc. all use Star or Mesh connectivity (see Appendix, Table 1) and proprietary MACs. They provide their own network-drives up power/cost/size for the Edge device. None use MAC-less simple protocols from device to propagator. None suggest an alternative to CSMA/CA and DCF with inefficient random back offs to avoid collisions and retries.

Random back off is equal—clients get equal access to shared medium on average—but it is not equitable—large packets are favored. Thus currently:

1. BLE MAC Flow: BLE Sensor→BLE multi-hop network→IP Gateway→Cloud. Contrasted with a low footprint MAC-less chirp-based protocol:

2. Chirp Flow is: Chirper→Modem (first hops)→Pub/Sub Network→Subscribers.

Battery powered chirp-like products e.g. AirTag, SideWalk, FreeStyle, Tires, use BLE. The Abbott CGM Freestyle, FIG. 50, logs data and then when near a BLE propagator, transfers it to Cloud. The Airtag and Sidewalk are rechargeable, but batteries in specialized sensors do not have to be. For example, batteries for sensors in tires need last only as long as tires last. None of these approaches address the globally relevant sparse density regions, developing economies, forestry or climate change challenges-not intended to be globally relevant.

None provide Cloud→Edge driven (re) imprinting, RF channels guidance, staggered schedules to avoid historical or predicted RF interference by IFTTT-like rules or realistic simulation, FIG. 6, 45, 51 see evolutionary wireless networks.

None use the notion of a propagator based logical network or applications residing in a trusted ecosystem (hosted or networked) to perform the heavy lifting in routing—enabling simpler edge—and progressive refinement (small data) along routing FIG. 18-20. None schedule shuttle buses, FIG. 12-23. None backward schedule based on time window of relevance and take into account the current network performance. None provide self-tuning and topology management via propagator networks aligned to subscriber bias and self-tuning IIoT traffic flow into progressively refined shuttle flows. None thus suggest a means to combine the coupled events as the time window of relevance of data reaching IIoT control systems, which is a function of when the packet is delivered and connectivity routing costs etc.

None suggest supplementing RFID like static information, FIG. 36 to include dynamic sensor-based data logs via store-and-forward mechanisms e.g. email, FIG. 1 and periodic shuttles, FIG. 18-20, as integral to techniques a globally ubiquitous minimally intermittent connectivity world may apply to address global uses for small, dumb, cheap and copious Chirp devices and their connectivity.

These implemented improvements may be broadly classified into categories,

Core Innovations taught in Ser. No. 13/627,883: To Allow Distributed Low power consumption Chirp enabled Sensor(s) to intermediately send chirps (intermittent broadcasts of small payloads of data); more specifically, chirps of measurements such as temperature, moisture, location to a network destination such as the AWS cloud by connecting each sensor to a Low power consumption Chirp Device and using chirp propagation to translate chirps to a standard protocol such as TCP/IP Based protocol and route the translated chirps to a Network destination to be processed such as by application specific web services hosted by AWS. Chirp device chirping patterns etc. may be taught by imprinting, thus shifting processing power out of the power constrained device and onto the fog/cloud-where appliances are powered.

### Chirp Device Connected to Sensor(s)

Minimal Radio communications Power Consumption
One or more sensors integrated with a chirp device with various subcomponents: radio, low power battery, etc.
Battery Powered (easily deployed anywhere without need for existing infrastructure)
Intermediately transmits Small Payloads from sensor(s)—using proprietary/non-IP protocol in real time or limited aggregated data if requirements dictate (while constrained to a small payload)
Chirp data avoids any significant interference with existing WIFI due to small payloads of chirp less likely to collide and in any event easily handled by sophisticated collision avoidance algorithms of high power WIFI devices.

. No intended receiver required i.e., transmits without any knowledge of receivers i.e. promiscuous open channel broadcasts. Broadcasts on configured channel and spectrum e.g., channel 6 of 2.4 GHZ WIFI.
Configured to transmit on specific channel and spectrum. (factory settable or field reprogrammable via simple means like dip switch settings that are only available from product licensee manuals, etc.)
Self identifies (e.g., chirp category, latitude and longitude coordinates, etc.)
No retries needed as no one measurement is critical as subsequent measurements will chirp.
Transmissions can be randomized for large deployments to avoid repetitive collisions (co-channel interference—crosstalk from two different chirp radio transmitters using the same channel). Randomness can be configured such as through DIP switches as needed.
Can be engineered to have long deployment of many years (due to low power consumption)
Can be engineered to be very low cost (due to minimum hardware requirements)
Can be distributed across very large spaces (e.g., citywide for parking availability or leak detection, industrial farming across many acres, etc.)
Chirp devices can be deployed sufficiently densely to make deployment resilient as device failure won't have impact as nearby operating devices will relay similar measurement. Thus, large deployments with minimal service requirements are possible.
Chirp devices may be low range for applications that have stealth/security requirements
Chirp device does not require any data Link layer or more specifically any MAC sub layer and by implication any GUID such as a MAC address. In other words, the chirp device can stupidly transmit the “chirps” and the chirp propagator can implement any higher level abstractions as needed for collision avoidance, MAC address/routing etc.
Chirp protocols may be distinguishable (Chirp-ID) but undecipherable. Innately secure, see FIG. 2-5, 16, 17. Tagging, FIG. 18 replaces IPV6 type routing but the packet size at the first hop from the edge device is kept terse.
Chirp devices may be throw-away or reusable without additional hardware cost. Setting modes on radio use (speak, listen, relay) is at time of imprinting, which may be factory default but then changed for RF environment etc.

### Chirp Propagator

Connected to destination network, likely a IP Network, such as AWS WAN
Configured to receive on specific channel and spectrum.
Configured to transmit to the end point/application on the connected IP Network.
Receives chirps from chirp devices within range.
Filter/Ignore all non-chirp signals on the configured channel and spectrum.
Filter/Ignore all chirp signals that are NOT on the configured channel and spectrum.
May filter out chirps based on signal strength.
May filter out chirps based on chirp device identity.
For scalability, Filters can be configured such that each chirp propagator processes payloads from a unique set of chirp devices in 1-to-many tree formation. Many to Many configuration is also feasible depending on specifics of deployment.
Can infer inoperable chirp device from long silences.
Can aggregate individual chirp data for transmission.
The level of data aggregation and delay will depend on the real time needs of the end-application.
Packages proprietary chirp(s) for IP based protocol transmission
Transmits IP Packets with aggregated data to the configured destination on the IP Network
Number of propagators can be minimized by allowing a propagator to move from point to point to receive from different chirp device data such as deploying on drone, vehicle, etc.

Core Innovations taught in Ser. No. 13/571,294 relate to “stacking”, avoidance—using time as the variable to avoid collision avoidance. The notion of collision avoidance in the RF space goes back to dynamic channel management Ser. No. 10/434,948, see FIG. 45 left panels. Collision avoidance in both time and RF space when applied together, drives dynamic scheduling for IIoT messaging, see FIG. 2,3,47.

Methods taught in Ser. No. 13/627,883, Ser. No. 13/571,294, Ser. No. 14/269,014 and references, resulted in embodiments for asset tracking, intrusion detection—early warning systems. The schedule-centric “Chirp-OS”, used and taught in Ser. No. 13/571,294 for logistics supply chains is revisited, relevant to globally relevant embodiments described.

### BRIEF DESCRIPTION OF DRAWINGS

In order to more fully describe embodiments of the present invention, reference is made to the accompanying drawings. These drawings are not to be considered limitations in the scope of the invention, but are merely illustrative.

These figures depict embodiments of large-scale messaging supporting millions of low-power or range-constrained terse messaging devices communicating with the cloud.

FIG. 1 is reproduced verbatim from a 2002 technical paper and referenced in the application “Low cost implementation for high performance embedded systems” U.S. Ser. No. 10/641,917, Filed Aug. 15, 2003. It introduces the notion of “thin devices”-low-cost devices with thin (intermittent) connectivity and store-forward protocols e.g., email, departures from the prior art of thin client (e.g., browser) and thick (always-on, ubiquitous) internet connectivity.

FIGS. 2 to 5 are excerpted from Ser. No. 13/627,883. FIG. 2 draws out the packet classifier for terse periodic “chirps”, 010 and VOIP Concat 020, detailed in FIG. 2 as part of Quasi-TDMA, near real-time transmission over a best efforts IP backbone. In FIG. 3, Chirps from phones are staggered, and there is a common time slice to receive block data from the cloud; see also FIG. 47. FIG. 4 and FIG. 5 depict the radio and protocol agnostic abstracted network where diverse radios and protocols may form a protocol and radio type agnostic logical tree based scalable network—with new radios and protocols added as needed. FIG. 6 from “Evolutionary wireless networks,” Ser. No. 15/908,108 depicts moving parts within the propagator, and its interfaces to radio ports see also FIG. 2. The PHY layer of the OSI stack is serviced by multiple radios to meet specific product-market fit conditions that include power, cost, and size constraints. In FIGS. 2 and 6, the lower MAC (Media Access Control), is the first point of entry in the propagator, a node in a trusted ecosystem. There, port forwarding rules and pruning may be efficiently done, see FIG. 6, 2003. However, software (slower and more power-consuming) processing may also be done by any app, hosted or networked, see FIG. 6, label 2002, where IFTTT-like rules are supplied by cloud services label 2001. These include learning digital clones (simulation) Label 2001. Thus, edge intelligence is delivered to “dumb” low-power edge devices. The edge protocol may be a simplified UART broadcast wireless protocol familiar to those practiced in the art. If collision avoidance is managed, then broadcasting is an efficient one-to-many one-way communication, e.g., radio stations. The wireless radios may also be set in listen or relay mode, per cloud directives. Note that decentralized means-CSMA/CA & DCF use inefficient random back-off techniques to avoid collisions. These can be modified to quasi-TDMA and be more equitable for small packet deliveries and bulk transports (FIG. 3), etc. Scheduled and terse broadcasts minimize collision avoidance issues and also detection by bad actors. Numerous means to achieve this have been taught in references and attached figures to leverage lower energy consumption and dumb devices.

FIG. 6, shows simulation, digital clones, etc., driving new IFTTT-like simple “rules” to drive chirp patterns to address toll cost/hop cost see FIGS. 24, 25 at each hop if needed of a multi-hop logical logistics chain of packet delivery, store and ship forward but aligned to changes in both network and subscriber needs and therefore managing schedules for pick-up and delivery from big picture cloud services, see references and citations.

FIGS. 7-11 teach aspects of nature-based large-scale receiver-oriented messaging, relevant Chirp networks, and its scalable implementations. Nature uses receiver-oriented messaging-the payload is terse, cryptic, innately secure, and minimally intermittent. Only intended receivers decode the payload FIG. 7-9. Others may derive some meaning in a shared wire-less medium (the air and sonic spectrum). Signaling in Nature is prevalent for symbiosis and corroborated (more reliable) data gathering, FIG. 9. There are also seemingly autonomous or semi-autonomous swarms and shoals, directed by low-level control, FIG. 10. From a bird's eye view, the network messaging topology resembles a tree with both under and over-the-ground topologies, FIG. 11, scales by order (n*log(n)) to service millions of devices see Ser. No. 13/627,883 and Small, Dumb, Copious published 2016.

FIGS. 12-15 show what simple edge devices look like. The IPod is a purpose-built, low-compute edge device. It intermittently connects via serial modem-like links to trusted apps running on a higher compute power “propagator,” the computer. The App is downloaded from the cloud server that manages multiple such IPods through verified user accounts. Music on multiple IPods may this be shared on an authorized basis—the basis for scalable publish-subscribe mechanisms. The flow is purpose-built-device and protocol→trusted-connection to IP gateway→IP packets to Cloud. These same principles relate to Chirp devices—simpler, stripped-down protocols for the very last mile, using customizable, extensible, organically grown (no standards bodies needed) modem-like protocols that chirp terse messages to a propagator that then knows how to route the chirp-based on self-classified pointers, akin to the distinguishable signature tune (bird call) of a specific bird species. The hardware and power needs are minimized. Battery life is extended to decades, with some management described in references.

The flow: Edge Protocol←→Propagator←→IP-Gateway←→Cloud is zero trust-based. The (imprinted) propagator is the bridge between the (imprinted) edge and the imprinting mother (Cloud). The imprints verify authenticity, ideally at a hardware level. Enterprises own assets and imprinting mechanisms specific to them.

Where the imprint microcode for chirpers or propagators resides is flexible. Phone radio access at the lower MAC level, above the PHY radio and kernel layer, is not available unless you make phones. However, a USB external radio (PHY) with an Enterprise imprinted propagator works—IP encapsulation and forwarding. Radio SoC OEMS like Qualcomm may add chirp protocol handlers at the kernel see FIG. 6, 48—Chirp radios forward to Wi-Fi or BLE without user-space apps. Sub 1 GHz Chirpers using Texas Instruments Chipsets may form a wireless sensor network with device-level authentication that does not use spoof-able MAC-ID, etc. Thus, microcode may be circuit-like but implemented differently.

FIG. 16-17 show the self-classifying Chirp protocol described in Ser. No. 13/627,883 Like Bird song, there is a distinguishable CHIRP-ID for a species—the stub for a topic-based addressing scheme-and an optionally private cryptic payload—e.g., the sensor data, decodable only by intended, trusted subscribers in the receiver-biased framework—where the bulk of computing and deciphering or decryption is on the cloud end. The Chirp-ID just needs to be locally unique in the region, based on the Schedules, Radio range, chirping patterns, etc. It does not need a global UUID like MAC-ID. Thus, 8 bits (1 byte) may suffice to delineate up to 255 distinct chirp species chirping in the same region and time. A one-byte payload, with check sum and optional routing navigation (the arrow), is a 5 bytes message. Chirps have been implemented as just one payload byte; the RF channel, chirping frequency, GPS location provide sufficient distinguishing characteristics for routing—no Chirp-ID needed. Additionally, like a post office, networks support lost mailboxes where deep packet inspection occurs. These are preferably in the cloud, with more computing power. Military edge products do have stealth chirp recognition modules installed as local semi-autonomous agents under cloud control; see publishing agents described below.

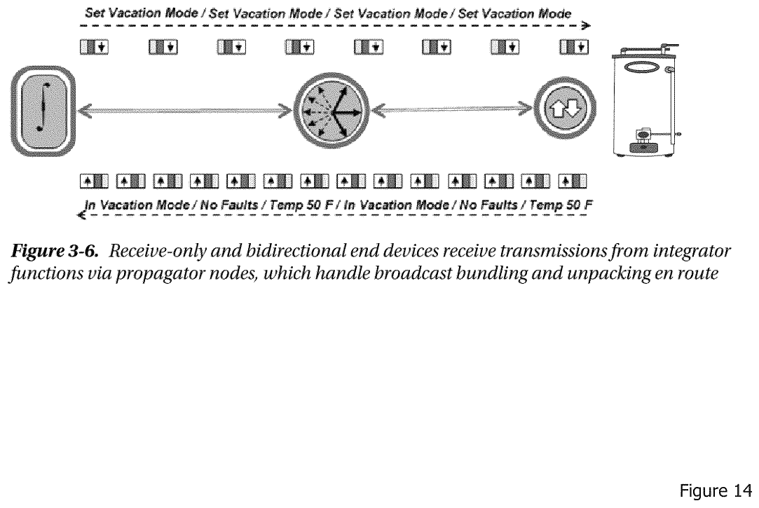

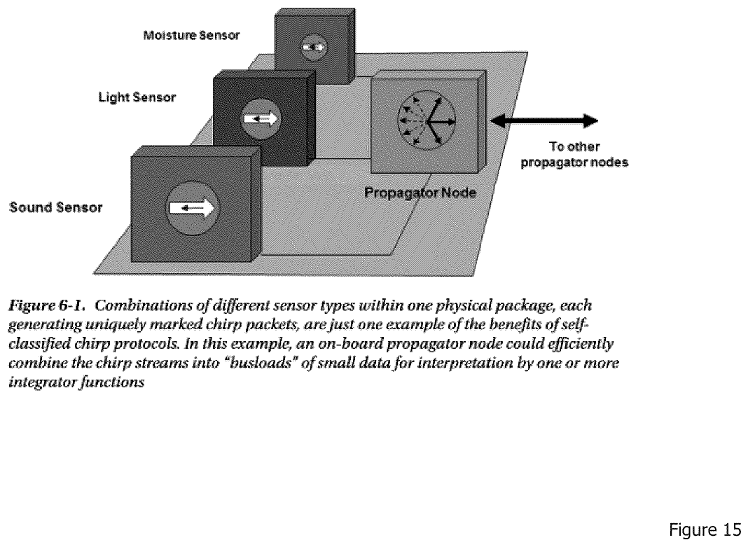

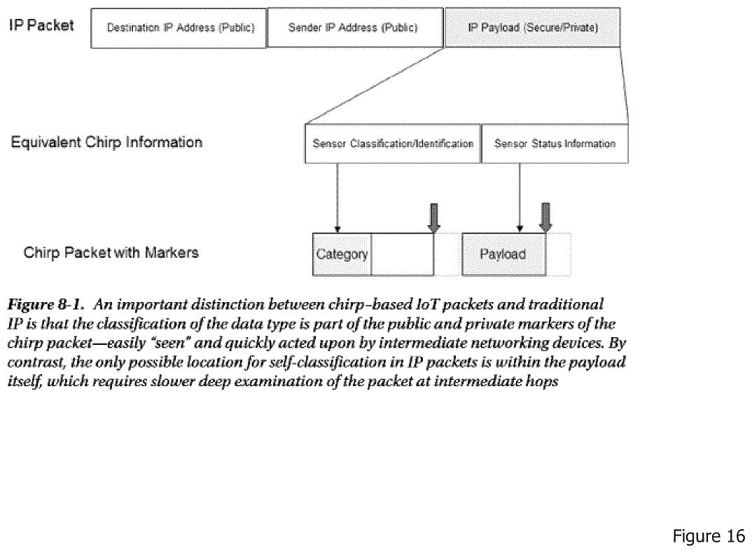

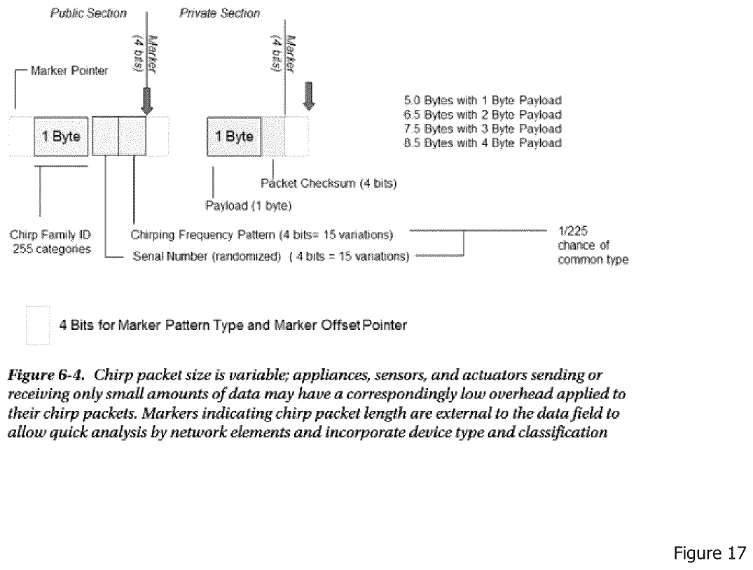

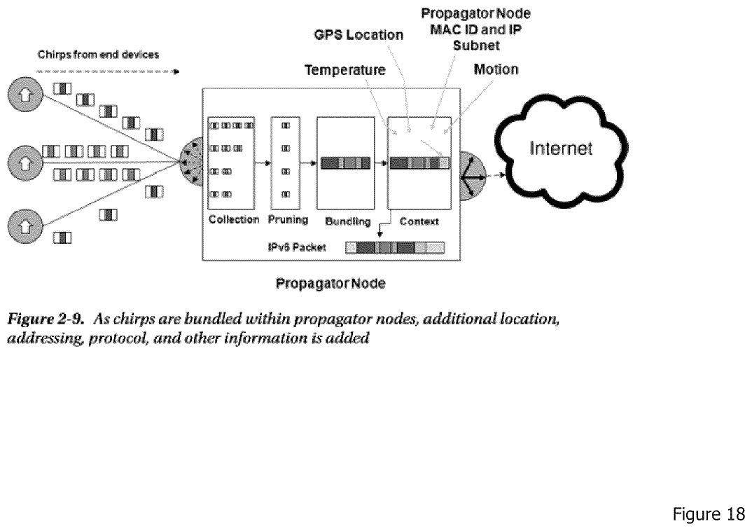

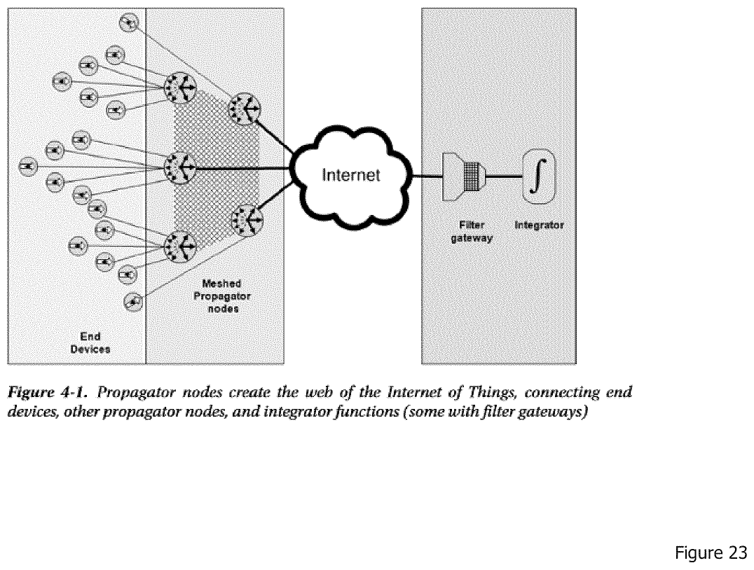

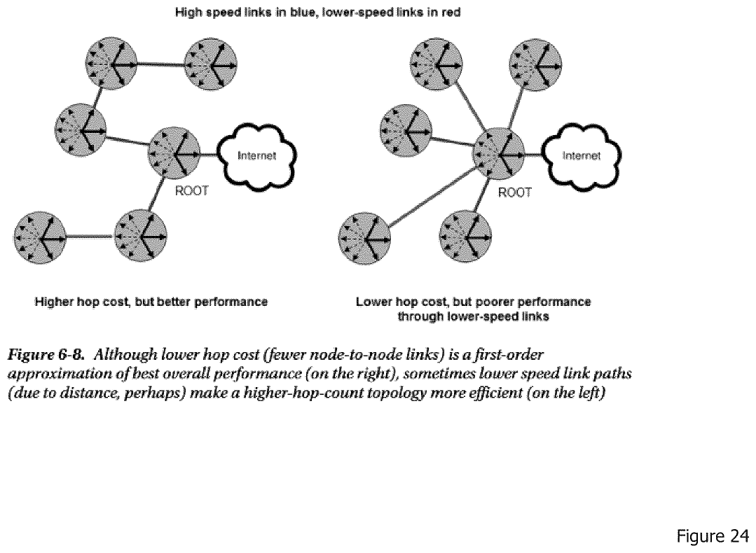

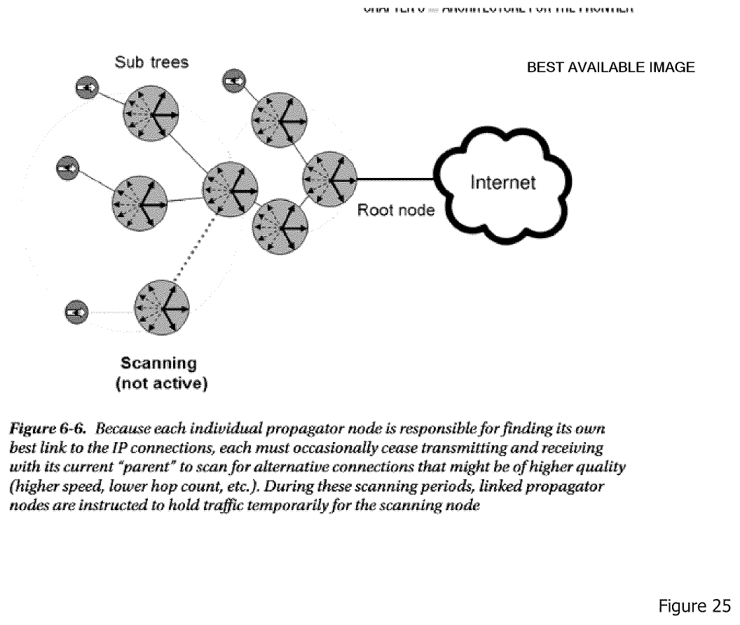

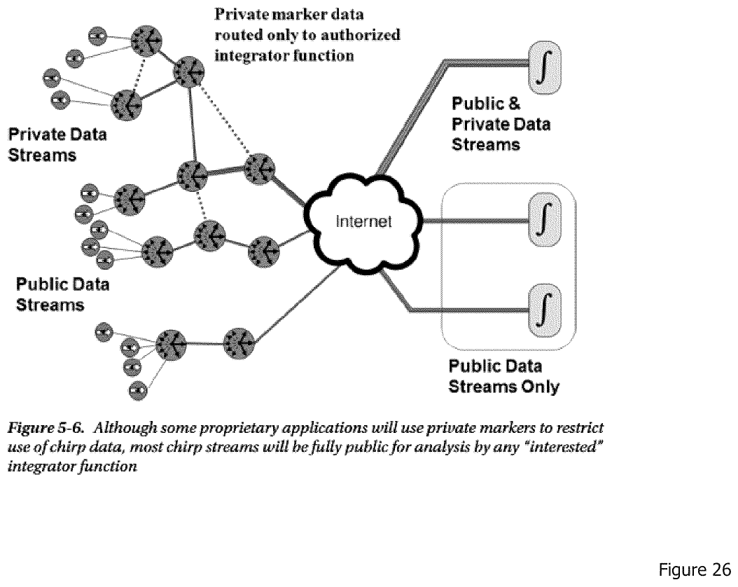

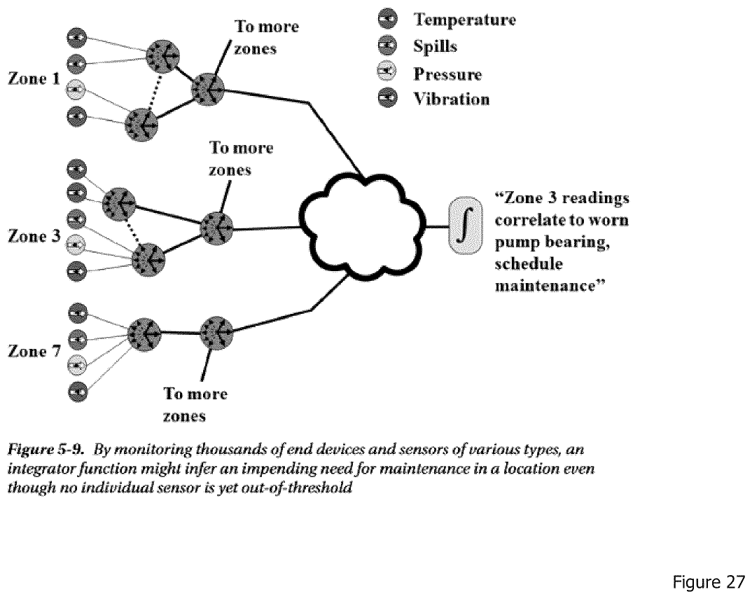

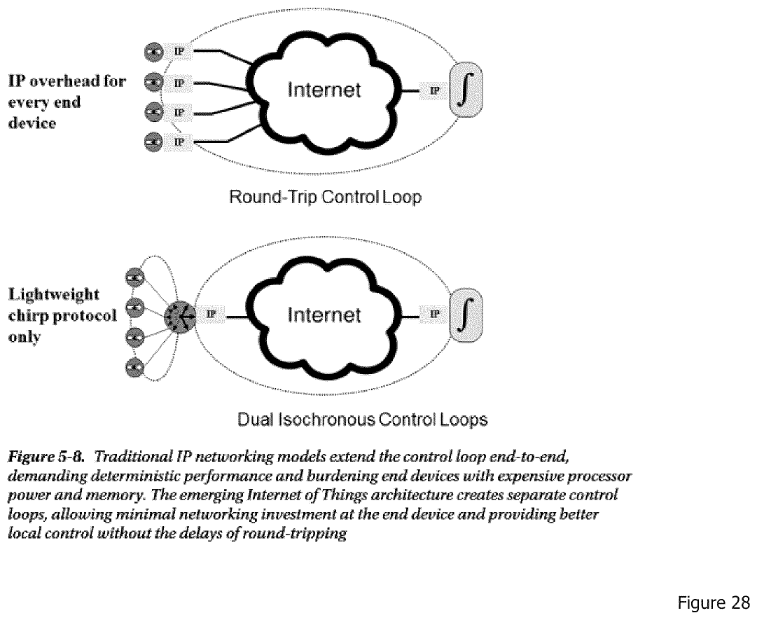

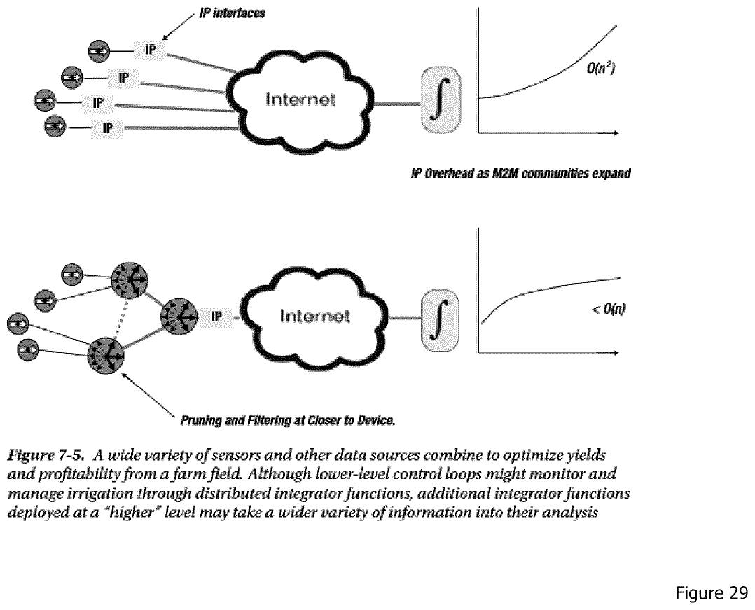

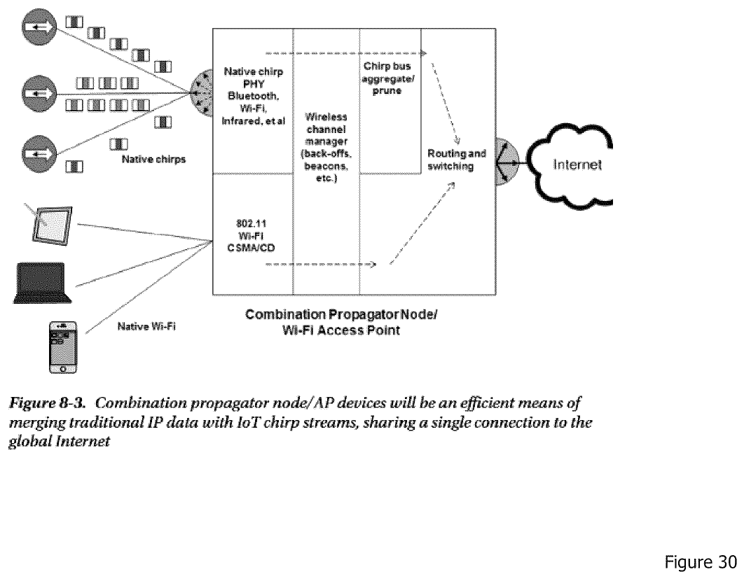

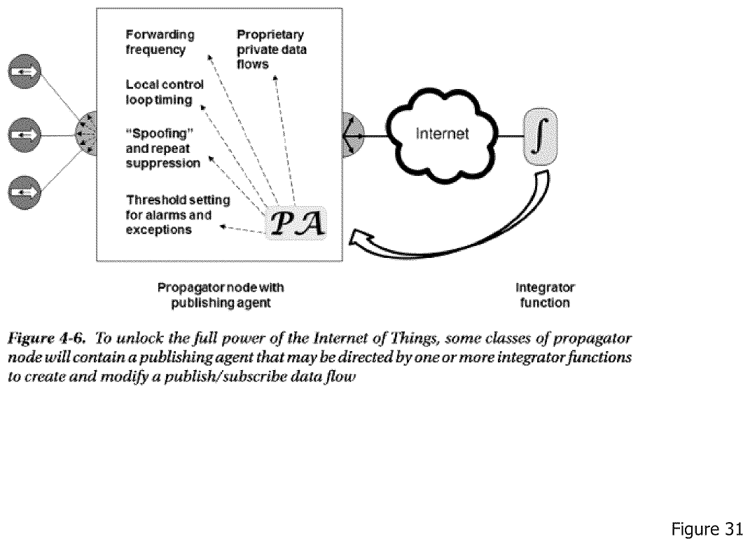

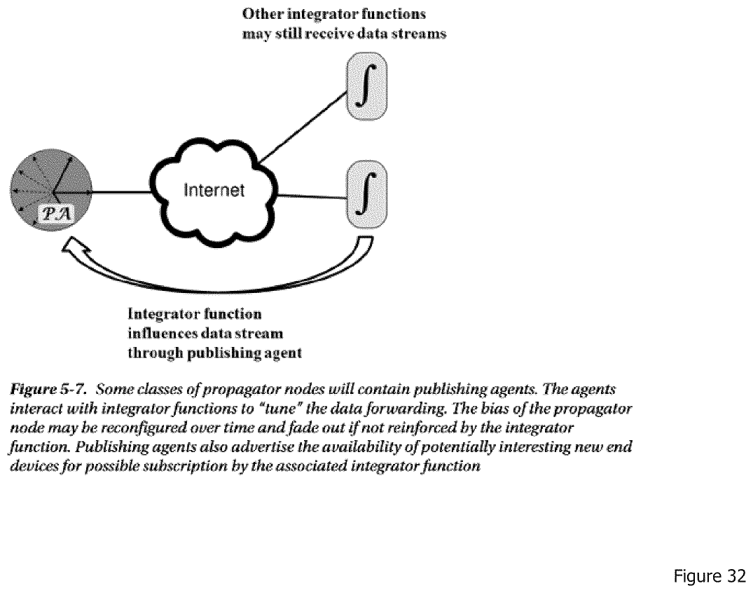

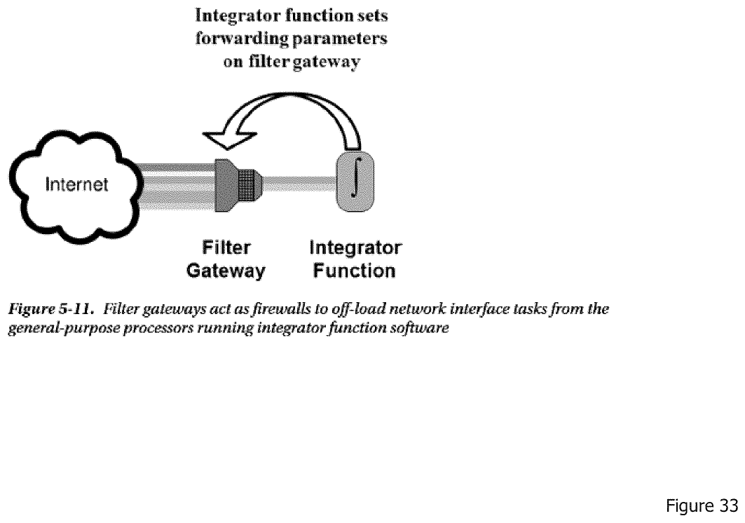

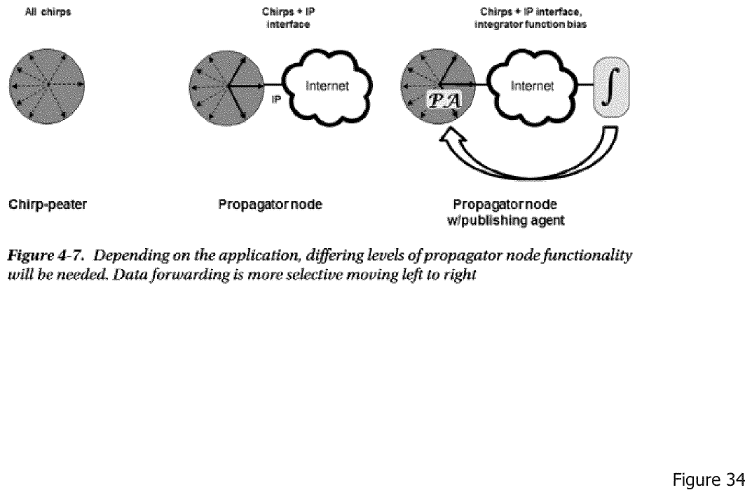

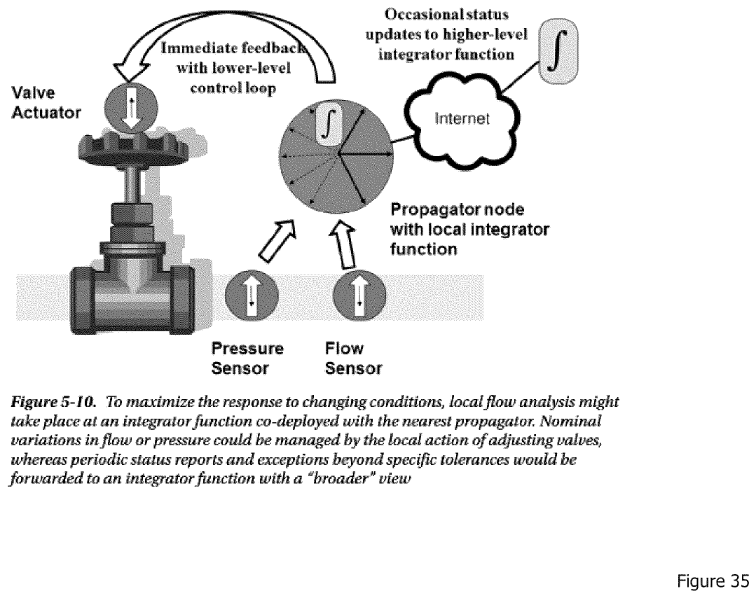

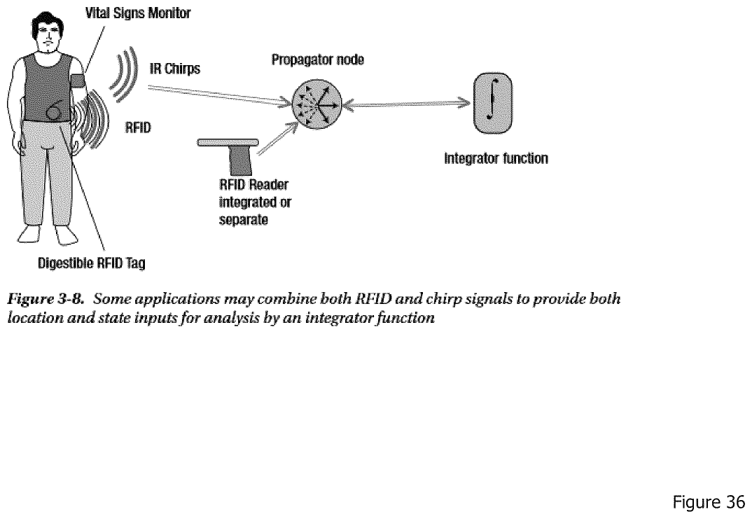

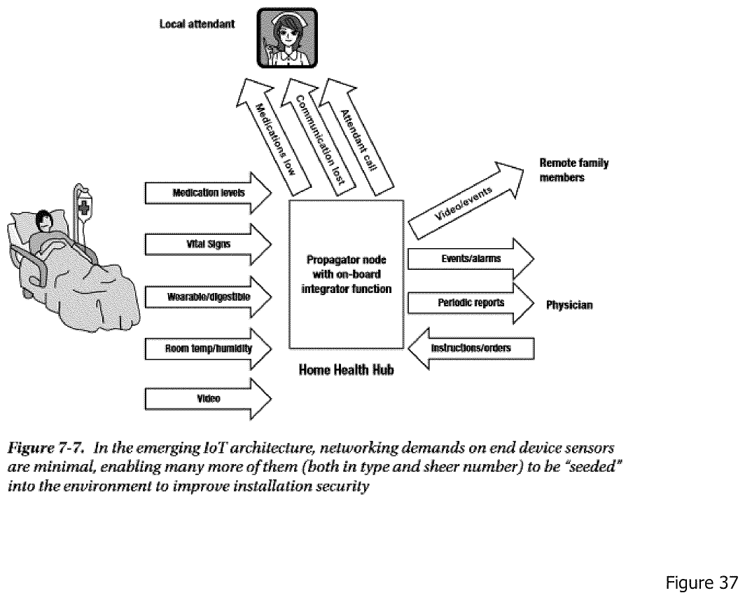

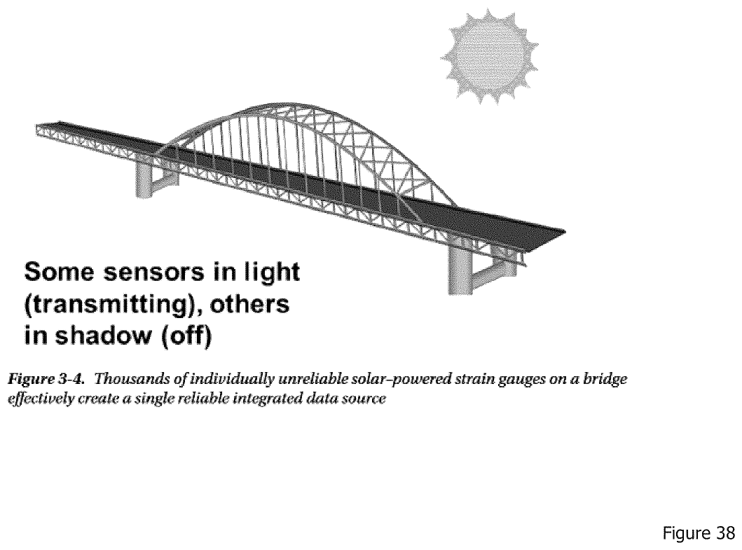

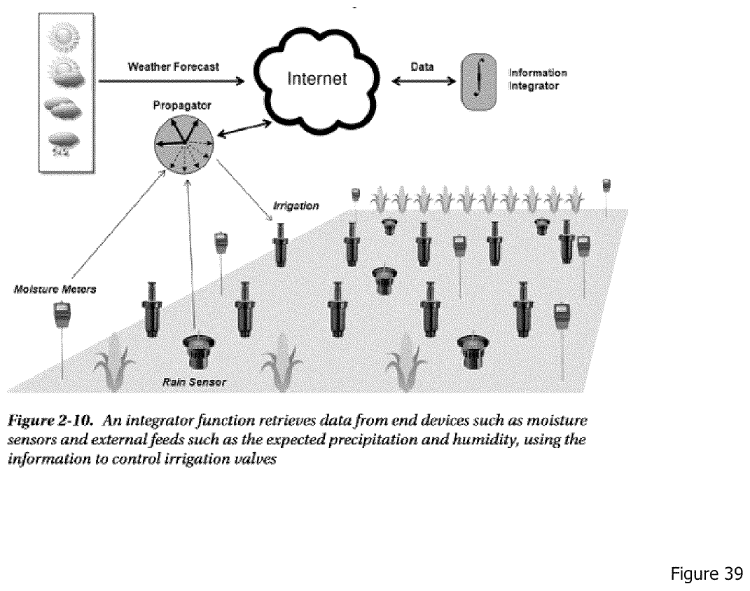

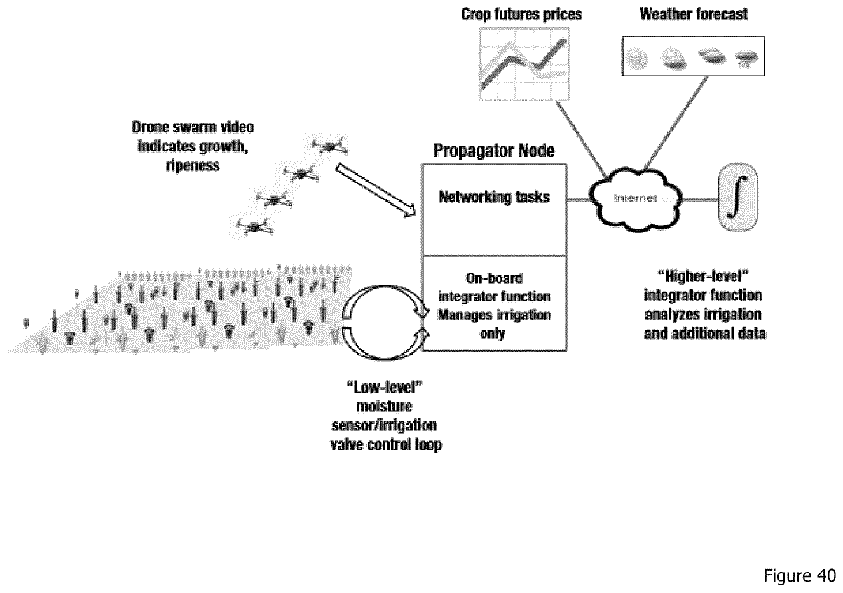

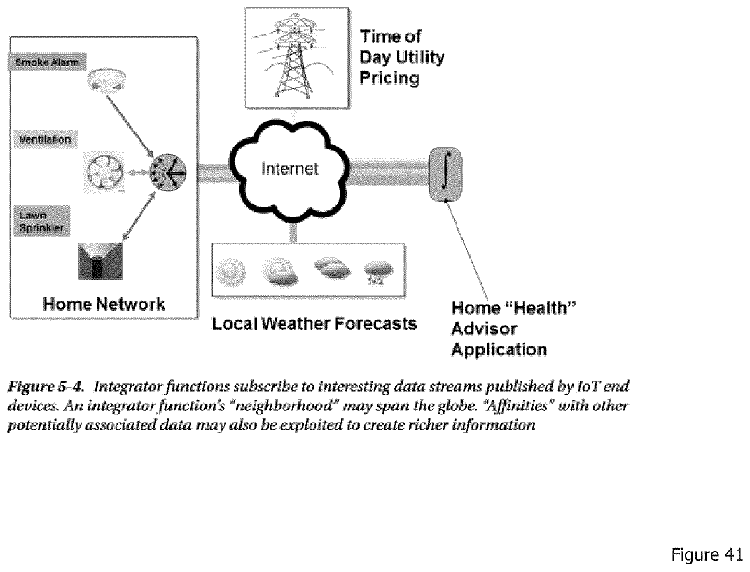

FIGS. 18-22 show methods to tag chirp data prior to routing. It shows pruning, collating, corroborating, and bundling to obviate extraneous traffic flow. It also teaches methods where chirp bundles piggy back on existing wireless networks. The self-classification scheme includes Chirp-ID, or its absence, also a type of classification, then the radio “port” on the propagator and its tagging. See also FIGS. 2-5 from Ser. No. 13/627,883 and a top-level view in FIG. 6. Protocols like Wi-Fi and Bluetooth are CSMA/CA and DCF aware—“agile,” as described in references and therefore can accommodate timed or untimed chirp traffic. The router may also set Quasi-TDMA-like reservation slots, see FIG. 22.

FIGS. 23-29 show the scalable logical tree-based propagator topology and its publish-subscribe topic/pattern-based messaging in scalable embodiments of device->propagators->integrators data flows. The range and power of the end devices are limited; the propagators act as relay nodes. A simple radio can listen, chirp, and relay, just not at the same time. It can also receive and re-transmit (relay) on different non-interfering channels. This forms the basis for logical tree topologies with an uplink and downlink arrow of transmission.

Chirp devices can, thus in addition to species self-classification, also provide (dynamic and extensible) navigation “arrows” to intended subscribers—e.g., Northbound to clouds, Southbound to devices in its logical sub-tree or east-west for siblings, etc. Thus, zone management of the broad cast application-specific heart-beats/chirps is dynamically managed for dynamic addressing, a departure from the prior art. The notion of toll cost and hop cost and scanning is described in references and relates to the tradeoff chirp networks deploy to conserve power, see FIG. 24,25.

Scalable, industrial, and military-distributed control systems have multiple layers of feedback and control; see FIGS. 28 and 29 on dual-mode control. Local lower-level and faster sampling is at the edge, where power or hardware constraints limit brain power. Higher-level thinking is slower by Nature and more compute-intensive. It is also where big data can derive deep, corroborated intelligence to drive updated chirp radio frequencies, timing, and chirp patterns.

FIGS. 30-34 describe the publishing agent—an interface to the integrator, how it influences filtering and forwarding by the integrator, and how it can be dynamically relocated, given currently available resources, to be closer to the edge, if needed, based on urgency and/or resource (e.g., power) management. This is also addressed by the toll cost and hop cost taught in references.

FIGS. 35-44 depict plausible use cases for chirp protocols and networks in health care, farming, structural integrity (bridges), home IoT, etc.

FIGS. 39-40 show a futuristic combined sensor seeding and data harvesting relevant to large-scale farming. A robotic attachment plants sensors along a path visited by a receiver radio mounted on drones, tractors or back packs. The sensor is inserted into the ground, with just a solar or thermoelectric plate exposed. The antenna may be integrated with exposed elements. Next, during insertion, the battery insulation is removed. The unit then automatically scans to be imprinted per private protocols. Chirping schedules and patterns are taught. Before the imprinting, the sensor unit and an interchangeable radio module—that suits that product market fit-are running factory default settings, customized in the field for current RF conditions, etc.

See also imprinting.

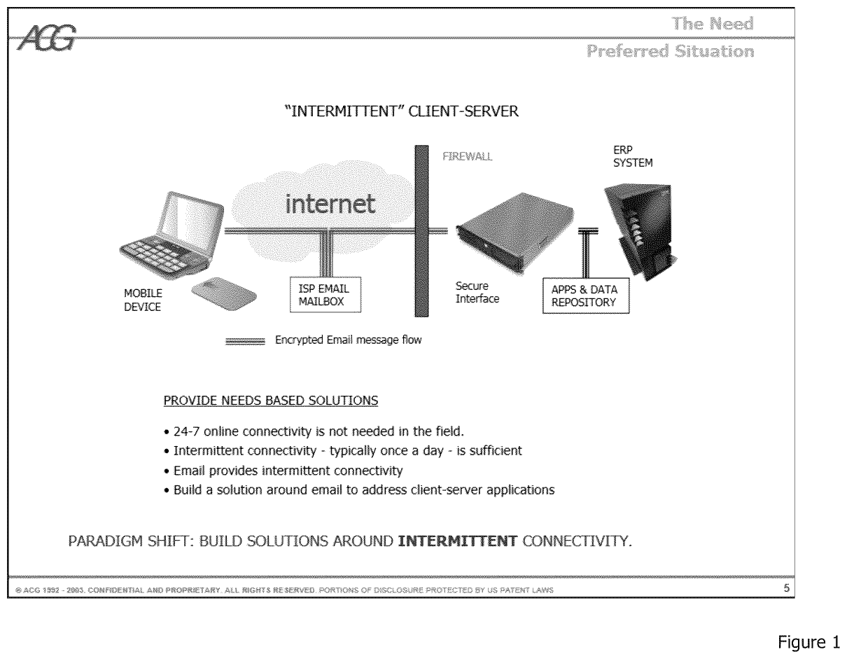

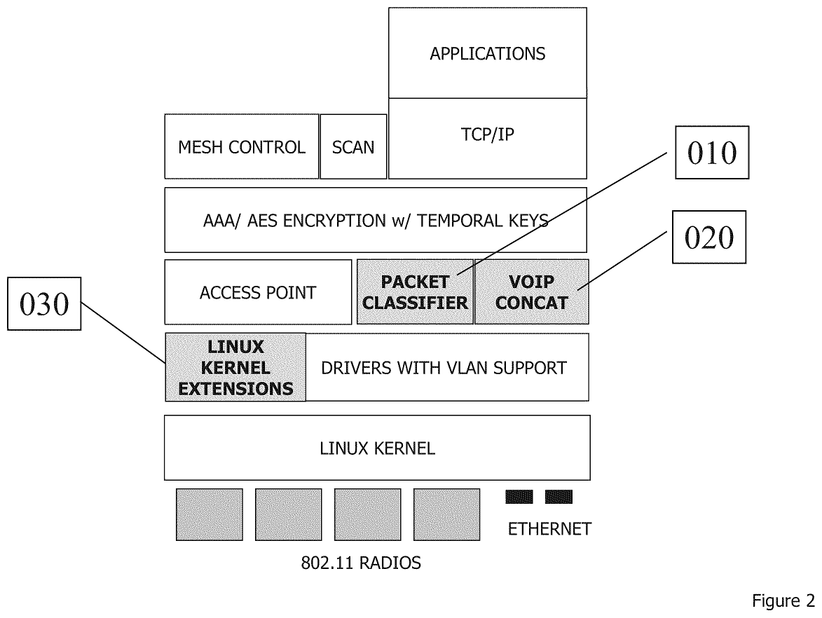

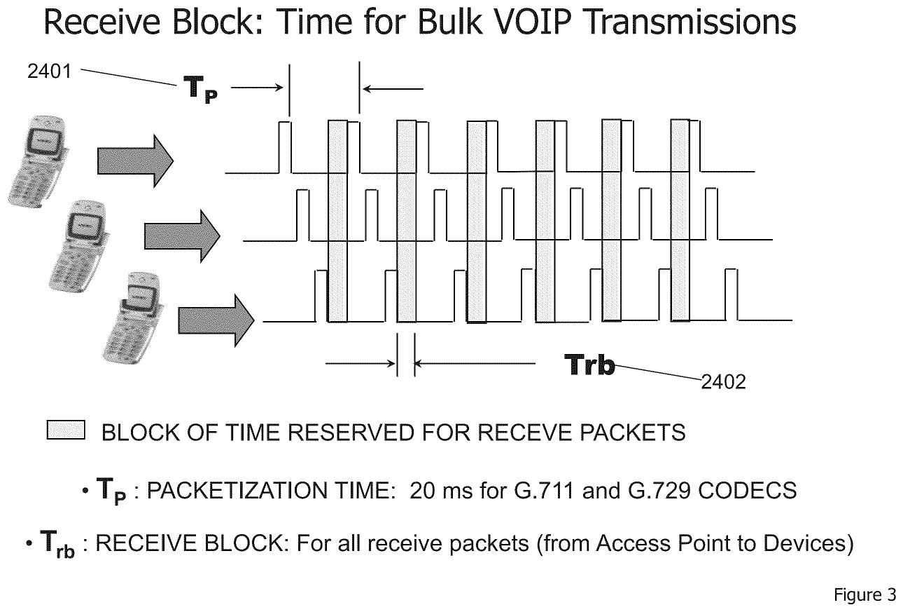

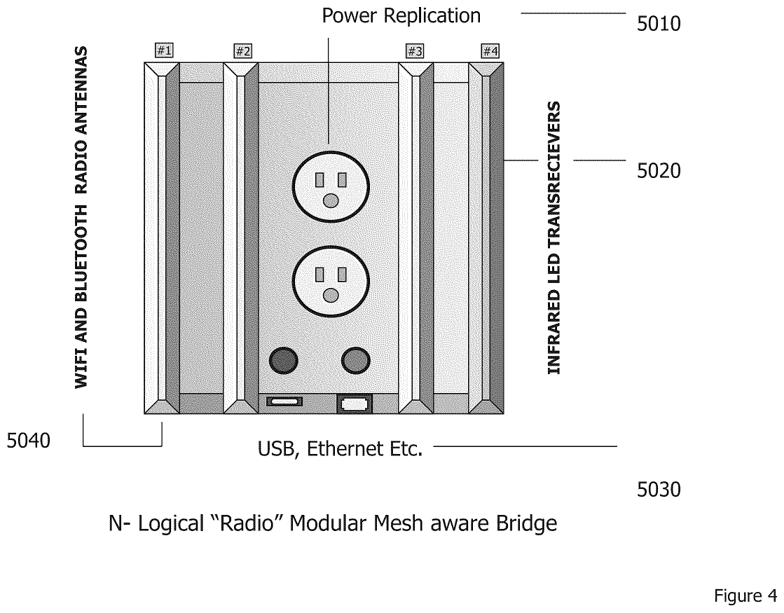

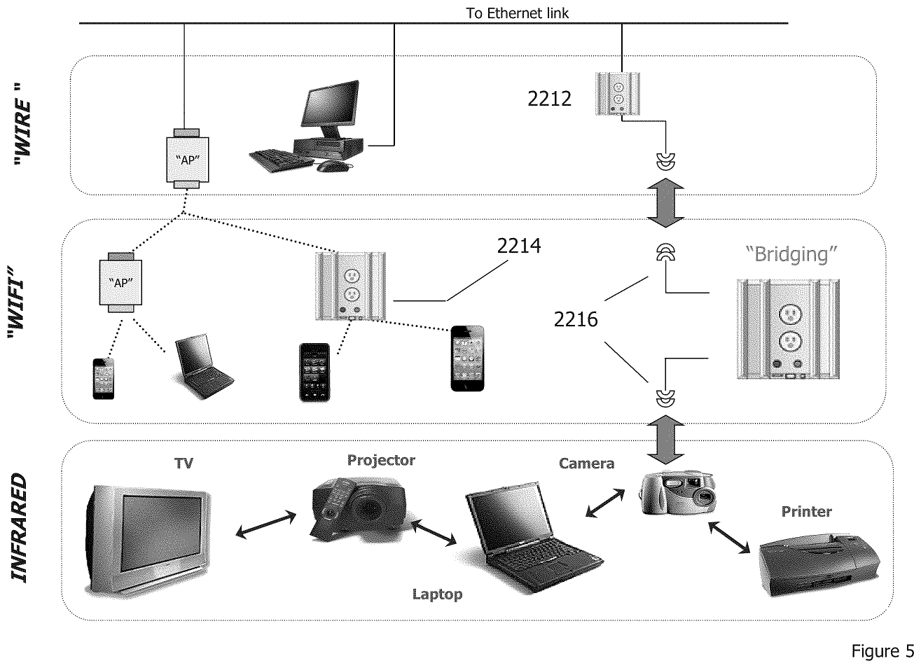

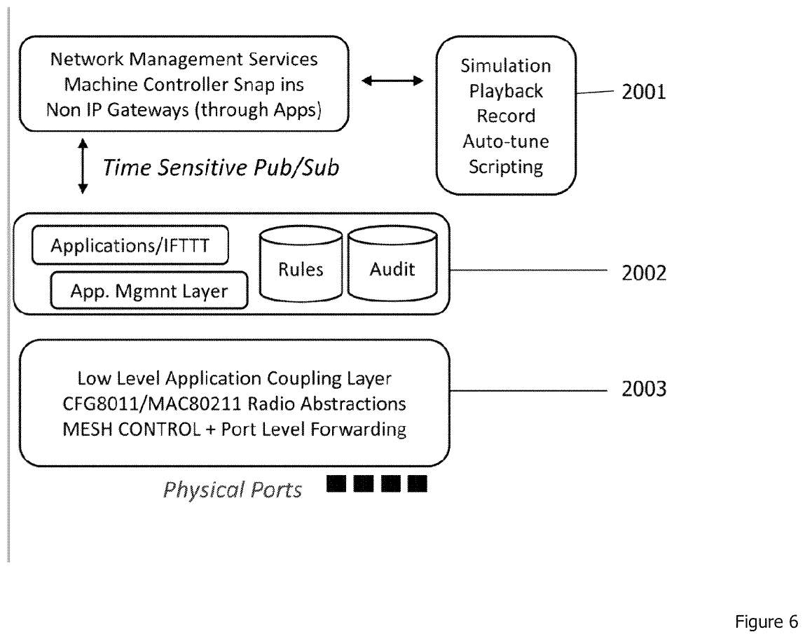

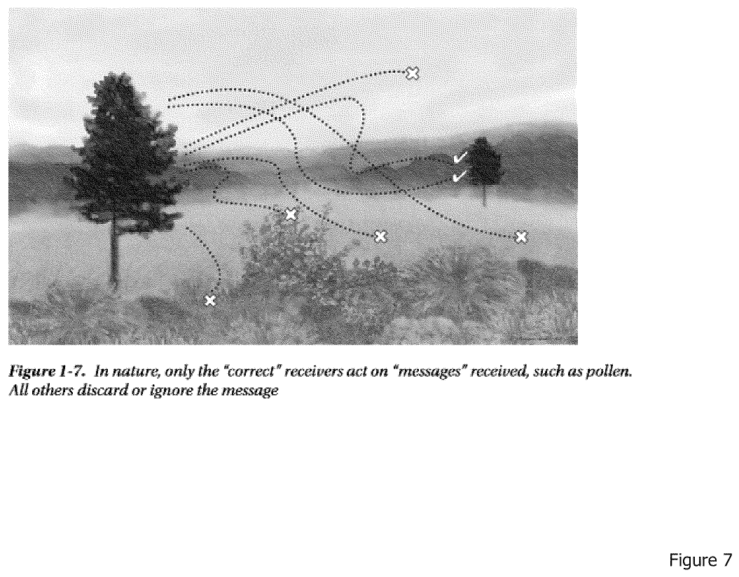

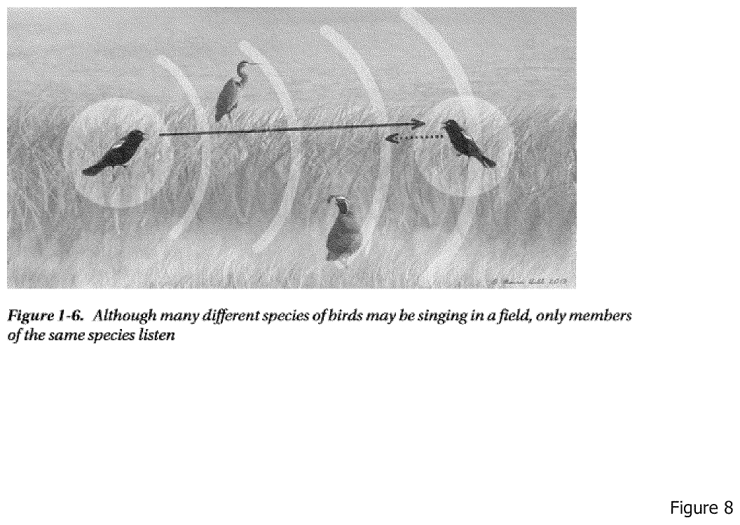

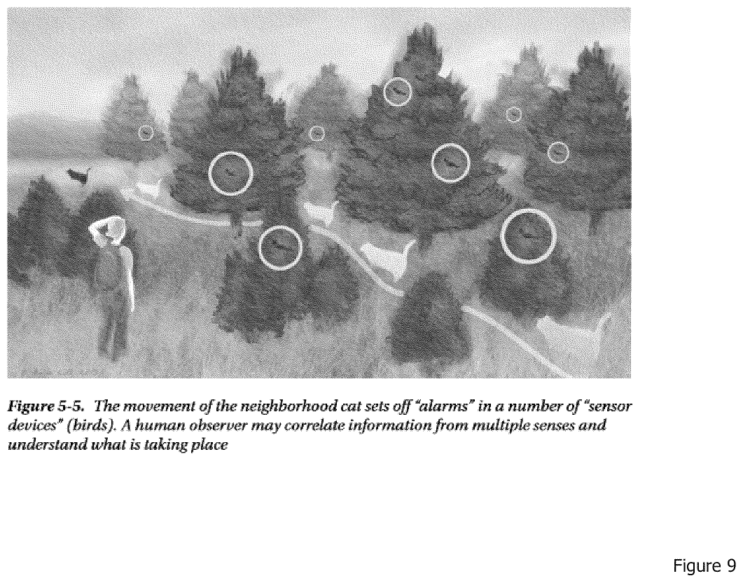

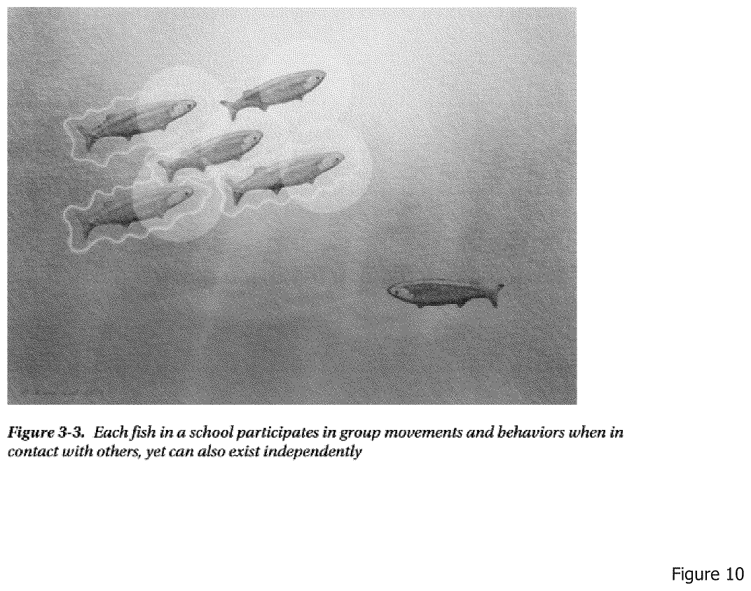

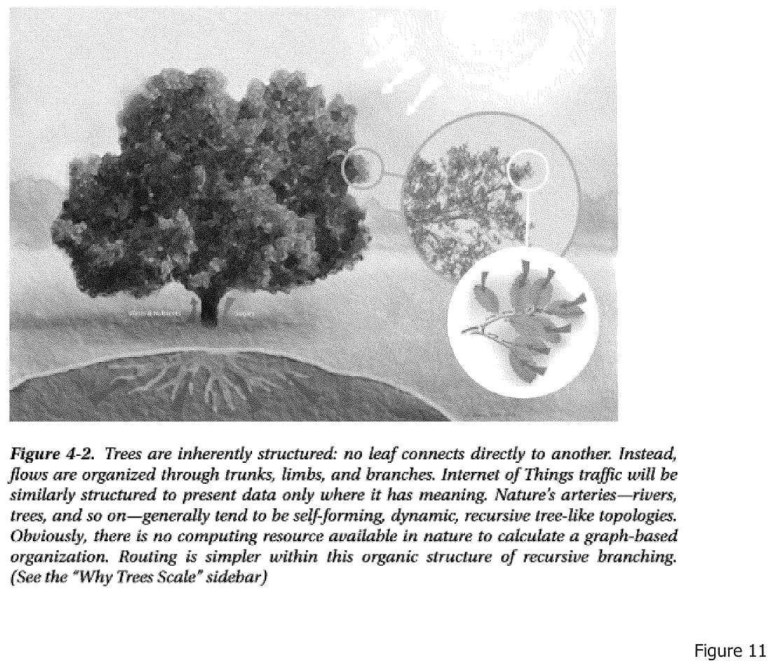

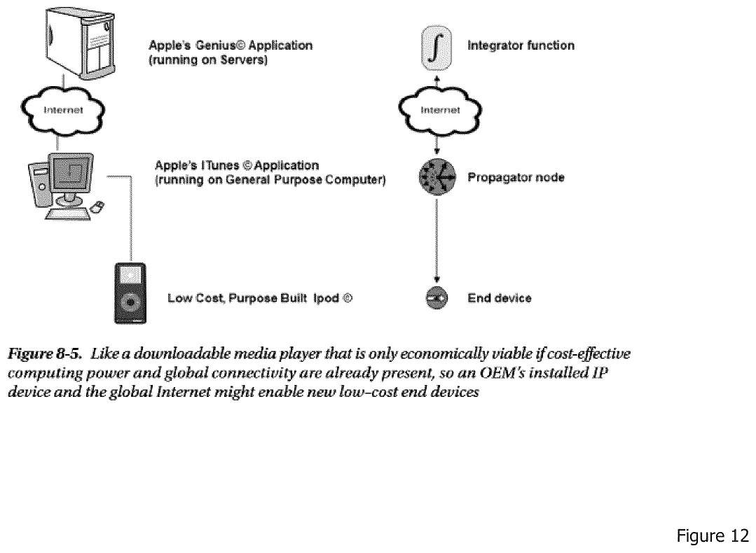

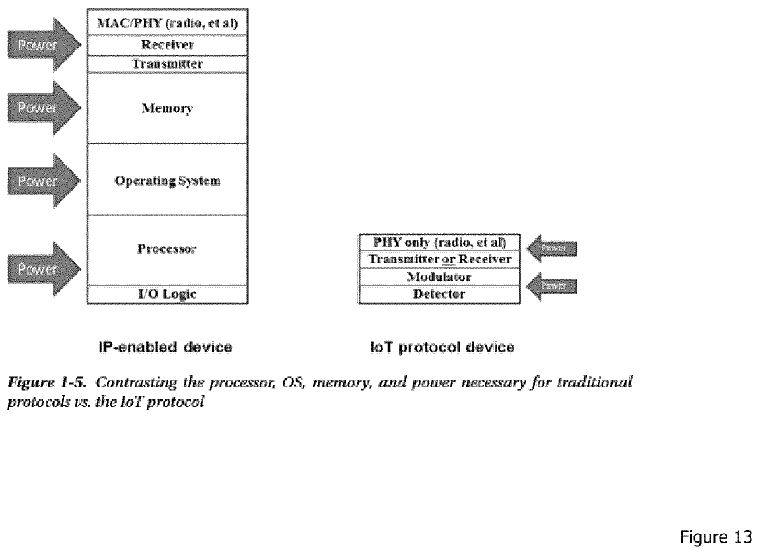

FIG. 45 is a variant of methods taught on managing toll cost, hop cost, and managed time delivery for Hybrid mesh networks emanating from periodic, collision-free chirper, relaying it to a pick-up point, where propagator software resident in the carrier pigeon or propagator, tags, prunes and routes to a message broker hub or directly to subscribers. The multi-radio mesh network architecture refers to tree-based dual uplink/downlink operating on non-interfering channels. Qualcomm's QCA4020/24 multi-mode SoC chipset integrates dual-band Wi-Fi, Bluetooth® 5, and 802.15.4 protocols. ARM-based chipsets are used on the edge, propagators, and cloud. They have trusted-zone imprinting on chirpers and propagators. Thus all stake holders may add one more chirp protocol or additional IoT-specific purpose radio—as opposed to a USB external modem. This internal chirp-aware radio and its drivers/apps may access protected storage (e.g., DRM in phones) to provide processing, bridging, and gateway services directly from the chirp radio to other IP-aware radios on the chipset, see FIG. 6, label 2003. Dual-band, physical tree-based, multi-hop Industrial mesh networks are thus ideally suited to provide logical tree-based chirp propagator network overlays—at any hop—and coexist with other radios and protocols and sharing RF and wired spectrum, see FIG. 18-34. If needed, USB-powered Sub 1 GHz IoT has better range and less congestion than Bluetooth 2.4 GHz and also less hops in sparse RF environments. Thin devices, FIG. 1—are cheap pigeons with intermittent connectivity to IP backbones. Chirps may piggy back on phones, drones, tractors, routers, and radios. Chirp protocols may also thus piggyback on existing MAC or IP-based networks. It is intentionally radio and protocol-agnostic-yet minimal, cloud-orchestrated.

FIG. 46, depicts how chirper-based tagging supplements RFID tags to provide a separately verifiable block-chain like ledger of events from raw source materials—even before RFID tags have been applied. Progressive tagging (routing information and concurrent internal data sampling) begins first with an originating “Mother” imprint—Enterprise set protocols that are distinguishable via a public Chirp-ID—for routing—but terse payload undecipherable except by trusted agents. For example, Red/Yellow/Green/Dead is perhaps all a cloud mother needs to know. Thus, the RFID “blaster” that energies the RFID shipper tags may also use an RFID++ blaster to wake up sensor-equipped chirpers, tuned to be alerted by sound, etc., patterns set by cloud “Mothers”. Data logs are then uploaded and mapped to legacy RFID logistics supply chains. Two independent logistics systems thus provide corroborated evidence back to a pre-RFID tagging time—when the chirper was first imprinted—provenance prior to RFID tags applied. When a RFID tag is applied, that information may be added to the data log to provide cross-referencing. Further, the chirp protocols are private and shared with partners—but this is a zero-trust chain—not reliant on any third-party trust—because you own the asset being tracked, and your cloud agent is doing the tracking via a friend-to-friend network potentially comprised of a logical tree based network of propagators, see Ser. No. 13/627,883 et al.

The RFID++ blaster may also add imprints on the device related to the estimated location based on signal strength and triangulation from other chirp blasters with known locations. A chirper with no GPS is thus told where it is. A minimal viable RFID hardware supplement would then be a legacy UUID-based RFID tag, a chirper, a wake up sensor, other sensors like accelerometers etc. to provide a log of events related to SLA or Customer Satisfaction. This “RFID++” is reusable and USB recharging is a green alternative. Further, this device-verified imprinted ledger/block-chain enables assets to be tracked in this womb-to-tomb relationship between edge and cloud—despite spotty, intermittent, untrusted, best-effort connectivity—the real world.

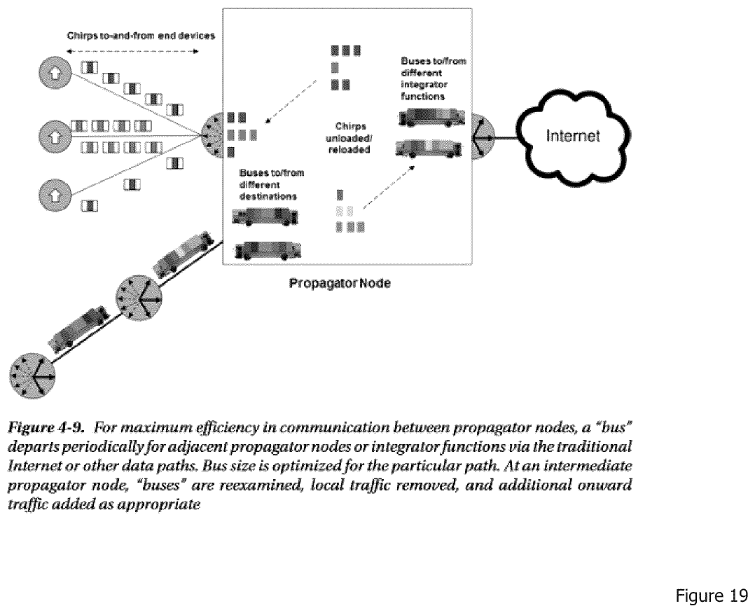

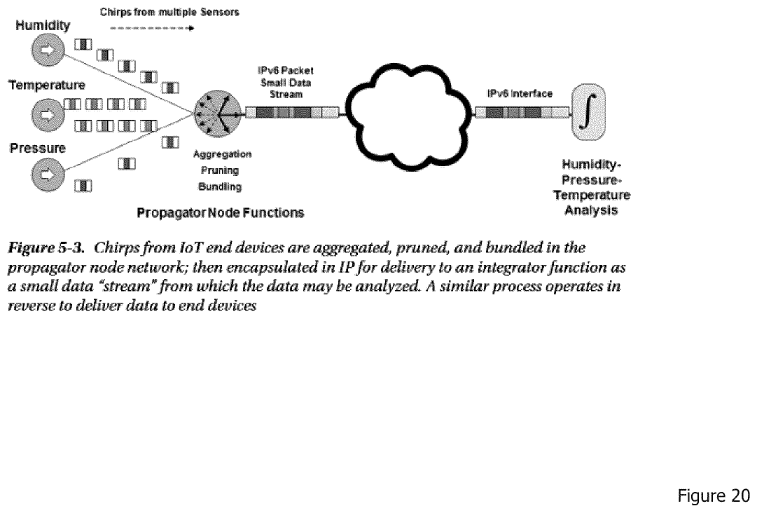

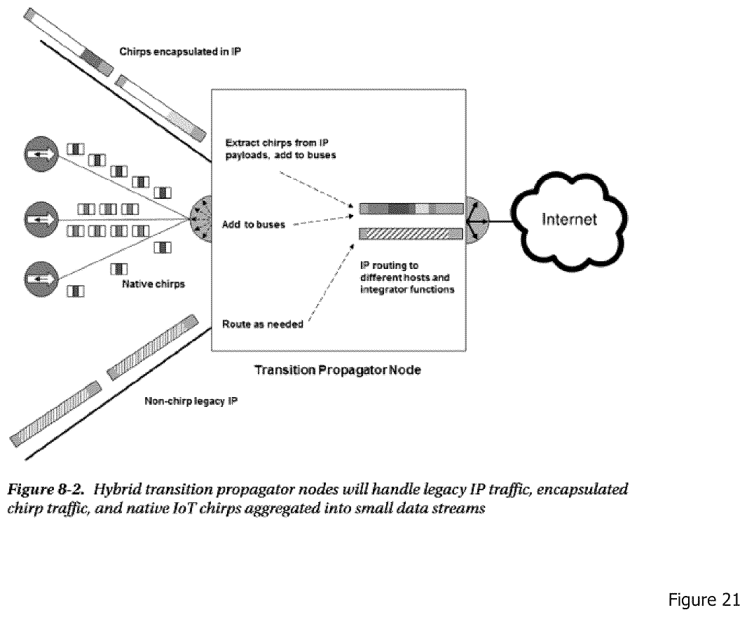

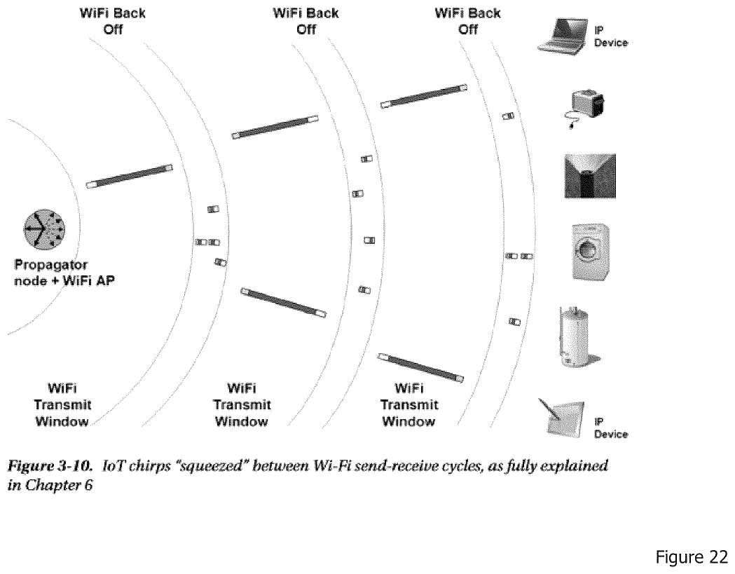

FIG. 47 and FIG. 3 show scheduling-staggered time intervals-for three VOIP chirpers on shared RF channel and their aggregation to a periodic container delivery. That scheduling and the segmentation of the collision domain in time, place, and channel/spectrum are based on the correct management of RF interference, see FIG. 45. FIG. 47 depicts scheduling when chirpers start, stop, and their staggered timing, FIG. 54 avoids “stacking”—scheduling start-stop intervals for chirpers and when the propagators need to be listening. Further, the duration of listening and chirping is tuned for reality—when there is RF interference, the listen duration is increased to 2× or 3× from the minimum 1× to pick up all there chirpers, FIG. 47. Further, if the time duration while Chirpers chirp is too long—for both stealth and power reasons—then the chirpers are moved by the cloud orchestrator to other RF channels—segmenting the collision domain, FIG. 45. The cloud orchestrator receives the RF scan information from its listener/scanner propagators and thus modifies—see Packet Scheduler and Egress Queuing in FIG. 48.

FIG. 48 is a variant of FIG. 2,6,45 and explicitly calls out Chirp as a supported protocol serviced at the PHY layer or the Lower MAC layer to provide a trusted—at the chip level—gateway to the IP backbone. Phone manufacturers do not provide access to the Lower MAC, and hence an alternative is to use A USB-connected radio and Propagator combination to perform the IP encapsulation and forwarding to message hubs, etc. Enterprise branded carrier pigeons—FIG. 1, is a globally relevant alternative to relying on third-party solutions to provide edge connectivity using any public shared media e.g., Radio, IR, Sonar. Once on the IP backbone, heavy footprint encryptions dissuade bad actors. At the edge, the combined effect of Cloud Mother→Imprint-able Edge device, is also now un-attractive to bad actors. The probability of detecting a terse cryptic scheduled chirp is difficult, especially since the cloud is changing the parameters—functionally equivalent to CSMA/CA, DCF for MAC addressable wireless devices. Further, back scheduling from when cloud subscribers need the data to when the chirpers transmit and their repetitive duration to be picked up by scheduled pigeons—no value in hacking—given its intended ephemeral Nature. Such ecosystems are zero-trust—no third-party certification is needed. This MAC-less protocol provides benefits for edge->cloud connectivity

FIG. 49 teaches the sanitized version of a military application embodiment of diverse sensors—represented here as ticker symbols-provided logs tracked sparsely from Aug. 16, 2021-Nov. 19, 2022, 34 samples. Simple standard deviation-based control ranges for ticker symbols (Chirp-ID) were plotted, and when the “performance” of the stock fell out of accepted ranges, then sampling frequency was increased. This, in turn, drove drone propagator schedules. The volume of the stock traded was used as an indication of interest—the number of active subscribers. This meant the pigeon shuttle schedule ran more frequently for some. The bus schedules and toll costs are “aligned”—see references. Next, there are marked correlations of “affinities”, FIG. 9, thus corroborating independent verification of trends. This is gleaned intelligence across Chirp-ID species.

Note that each symbol's time series is synchronized with the other ticker symbols, and therefore, correlation is easily established. In the design of multisensory patches that can be easily deployed in both outdoor and indoor environments, the type and number of sensors Ideally provide both inverse and direct Correlations at the local level, that is to say multiple sensors in the same sensor patch and also at a scale level such as sensors patches in every hotel room that communicate to the building automation system and detect mold overheating motion detection etc. Such sensor patches may then be easily installed as night light embodiments, FIG. 44. Other applications are depicted, FIG. 35-41.

Multiple sensor types provide a wide spectrum of information to establish corroborated evidence. For example: both dark and damp environments favor mold growth over time. Two sensors for light and moisture generate data streams that show corroborating patterns, and thus gleaned intelligence can drive the building automation system and hotel room service. Further note that the sensor patch containing multiple sensors to cover a wide spectrum of information are reprogrammable and thus threshold levels can be taught such as red yellow green and black—for dead or inactive (RYGB). RYGB strands is akin to Digital DNA for programmable and hence evolutionary IoT. The Strand of RYGB time series can be mapped by existing DNA tools to discover and predict potential run away conditions like mold in hotels, forest fires, integrity of buildings and bridges, etc. Contrary to the prior art approaches, simple, low-cost, low-power sensors are being copiously deployed to cover the full spectrum of data needed from the physical environment to maintain a safe and secure environment. The total cost of ownership is significantly reduced simply because edge devices do not require costly edge processing in terms of both CSMA and end-to-end encryption. The first is eliminated by using scheduled and timed broadcasts, see also FIG. 57, 58. The end-to-end encryption is provided through nature-based imprinting without the overhead of MAC based addressing and bulky protocols. Further chirp protocols are intentionally open. Enterprises can doctor their packet structures best suited to their RYGB digital DNA timestamped data strands. Generic algorithms have been used to generate worst-case and best case prediction curves and can drive decision support systems at an enterprise level, see also FIG. 57-58. The mapping of sensor RYGB strands from individual data streams evolves and is also hierarchical and thus provide increasingly refined but still terse information strands. See also tunes described in references.

Thus, raw data from sensors is tersely converted to RYGB strands, and thus, the device and protocol are abstracted and fit into a digital DNA model. Similar species may provide symbiotic messaging (See also small data in references).

Thus, all hotels owned by a hotel chain may thus benefit from discovery and prediction of mold contamination and its remediation in one hotel and apply the imprinted IoT edge control system strategy (FIG. 35, 41), broadly. It is ground truth data that has been corroborated intelligence gleaned from patterns of RYGB strands in one embodiment. Building automation systems often work on silos of data from HVAC, lighting sub-systems that don't share potentially symbiotic messaging. In contrast the sensor patch provides a historical wide spectrum scan of the overall health of buildings gleaned from multiple sensors copiously spread at the level of granularity needed. Further, the sampling rate of selected sensors can be modified at each scheduled data log delivery—on-demand, subscriber-driven data harvesting.

Hotels may provide guests with an app on phones so they can verify the room is mold-free. Guests may use their own portable sensor patch. They can independently provide hotel reviews on social media, thus providing informal regulation. Similar informal regulatory uses of sensor patches may be used in other densely populated and potentially contaminated environments.

They may also be copiously spread in areas like refugee camps or forests, where an outbreak spreads like wild fire (see also section later on Chirp grids). By spreading these inexpensive low-power sensors copiously, we are collecting large data sets for digestion by AI, and our pattern matching algorithms are tuned for RYGB strands and snippet recognition across a wide range of physical environments. While Satellites can provide global outdoor coverage, they cannot, on demand, provide high granularity (e.g. hotel room level) sensor feeds.

Small Dumb Cheap Copious, it is contended, is the future for evolutionary IoT—a combination of terse chirp protocols and the ability to derive deep, actionable intelligence from those strands if time series histories.

FIG. 50 exemplifies this data flow: Trusted Edge→Data logs→Trusted Pigeon→Cloud Mother. The collection of data is separate from its transmittal-this minimizes power usage and signal detection. Transmittal mandates a recognized relationship with the enterprise-developed propagator and its connection to an enterprise-developed sensor, and directed from the cloud—that registers the current sensor with a medical account of user and the provenance chain from edge to cloud. Sensor data reaches the cloud and available to a trusted community of care givers—subscribers. Similarly, Trust-provenance-chaining, as in mother-child imprinting are exemplified in methods taught for globally relevant zero-trust connectivity for corroborated Chirp based IoT.

FIG. 51 teaches methods to model digital mirrors of network states by accurately modeling both the control algorithms, FIG. 45, and the radio and region-specific Nature of Wi-Fi or other wireless protocols. It does so by using virtual machines running the exact propagator software for imprinting chirpers with schedules, channels, etc.—methods understood by those familiar with the art. What-if situations were modeled within a hierarchical logical network topology, FIG. 45, and resembling the back propagation neural nets. Algorithms with node inputs the toll cost of a popular route and hop cost of more latency is weighed against the effective throughput for all tenants of the network service. This becomes more complicated when periodic bus schedules—running on this dynamic topology-are planned for Edge→Propagator→Cloud scheduling. Changes in the topology and routing then generates jitter in bus schedules, which needs to be managed to meet deliveries within the time window of relevance. The algorithms selecting the parent in logical tree networks is based on these metrics as is the scheduling of buses running on them, see references. This is a coupled problem and like all logistics supply chains lends itself to identifying repeatable patterns. Further some carrier pigeons (phones, cars) are directed by humans, not part of this digital ecosystem-these patterns must be learnt. The neural net that also models network topology and manipulates weightages to meet critical bus schedules—solving for topology and time window of relevance.

FIG. 52 is reprinted from Qualcomm's 5G white paper, FIG. 3 identifying Key challenges for “Massive IoT”, notably “Small Dumb, Cheap Copious—and Secure”

FIG. 53, depicts how the cloud VPN joins two isolated clusters to form a logical contiguous cloud—a collection of federated, opted-in shared devices and their networks.

FIG. 54, shows results from the simulator for collaborative scheduling—where blue and red start-stop transmissions are shifted to reduce stacking (latency and pipe capacity). See also shuttles FIG. 19, staggering and bundling, FIG. 3, 14, 21, 47. The scheduler is integrated with the network monitor, FIG. 45 that manages propagator software running on connected devices, often multi-modal, multi-radio, and multi-protocol, FIG. 48. This combined capability is called Cloud Orchestrator.

FIG. 55 shows an exemplary Soft Chips Work Flow: Imprinted Sensor->Logs->Modems->Pigeons->Tagging->Cloud->Publish->Evolving Edge Intelligence.

The steps shown are:

### A. Sensor Pack Order Fulfillment

1. Customer selects Enterprise Provided Soft Chip, e.g. Sensor Patch.

2. Enterprise delivers unit with QR Code

3. Customer attaches Sensor Patch to Legacy Edge Asset.

4. Enterprise App on Phone takes a picture (fingerprinting) of installed Patch

### B. Use Carrier Pigeon to Scan Local RF Channels (as Needed)

1. Enterprise phone radio or USB radio scans RF interference.

2. Information relayed to the cloud or App requests User entry.

3. Initial RF Channel and Schedule proposed and accepted.

### C. First Power Up, Pairings, Establishing Provenance Chain

1. Customer removes battery insulation. The unit powers up.

2. Unit searches for “Mother” per Enterprise first-time configuration.

3. Chirp-aware receiver radio—on a phone or USB modem—responds.

4. Request to switch channels, etc., sent (Control Plane Messaging)

5. The unit acknowledges and restarts with a new setting.

6. Carrier Pigeon App also switches to new Channels.

7. Imprinting over now cryptic Serial modem completes.

8. Data log initiated with First GPS location and time stamp.

8. Unit reboots. Pairing and Provenance established.

### D. Delivery of Data Logs Per Schedules or Sensor Triggers

1. Carrier pigeon visits at scheduled delivery time OR

2. Unit sensor detects trusted Carrier pigeon presence.

3. Unit Chirps received by pigeon. Pigeon responds.

4. Unit transmits data log over imprinted serial modem settings.

5. Carrier pigeon tags data logs with GPS+Time for audit trail.

6. Encapsulated packet—with Chirp ID etc. Sent to Message Broker.

### E. Delivery of Next Imprinted Code Settings

1. After Delivery, Unit requests new instructions

2. Unit uploads new imprinting instructions.

3. Audit trail logs updated to cloud via pigeon—when connected.

FIG. 56 shows an exemplary Soft Chips Embodiment where a Texas instruments development tool kit may be deployed to provide a BLE (Bluetooth) gateway. The Master control Unit comes with a Sub-1 GHz radio that supports UART modem-based communications for low-power usage Chirp devices. The modem is efficient since it does not need to be concerned with MAC-based protocols e.g., CSMA/CA. Also, the Chirp protocol is intentionally terse. Consider then a 100 byte payload—the data log—consisting of 20 samples of 5 bytes each. One byte may be sufficient for the topic-based addressing scheme (Chirp-ID), leaving 4 bytes for 4 sensors, 1 byte each. The granularity of the data is, therefore, approximately 1/250 of the range needed and the software can provide the mapping. This is delivered per schedules imprinted and drives the listening sensor on the chip for pigeon arrival. It then wakes up the communication unit to effect the data log transfer and receive new instructions. In terms of work flow:

56.1 Connected Device Userspace or Kernel space “App”:

|-- To Cloud Message Brokers (e.g. SMS)

|-- Download Configured Exemplary Templates

### Network Extension Support

|-- Provide Simple Relays over BLE Mesh

|-- Connect to Covert Global Scale Networks

|-- Restrict or extend network reach.

|-- Leverage Tree based scalable networks.

56.2 Soft Chip Executable Agent is told

|- What to do—sensor read, 1 byte mapping.

|- When to deliver schedules and listen

|- Tamper proof—Reset after pick up

|- Imprinted with new schedules & Programs

|- Rechargeable, Multi sensor usage

|- Embodiments in RFID++, Chirper Grid etc.

FIG. 56 is also referenced in the section on Minimal Viable Products.

FIG. 57 describes the implementation of a system for scheduling the events of imprinting and data harvesting, a time-synchronized time series of data streams. Note that diverse channels may be deployed to support modalities such as birthing, imprinting, and relay modes such as wildfire modes. The Channels A through D define an exemplary approach to ensure end-to-end encryption and still use broadcast modes. These modes also allow multiple secure broadcasts or pigeon to specific edge devices. Messaging in both control and data planes use collision avoidance in both RF and time slots to following timing diagram sequences that include a retry session. Thus interference, poor signal strength etc. are addressed through multiple chirp “tunes” described in references. As the section on Exemplary Terse protocol indicates, the Chirp are terse, since this is receiver oriented messaging. It also leverages the imprinting process to reprogram end devices as needed by subscriber interests.

### DETAILED DESCRIPTION OF SPECIFIC EMBODIMENTS-GENERAL OBSERVATIONS

Globally Sustainable Ecosystems Edge-to-Cloud networking in consumer IoT—Amazon Sidewalk Apple Airtag, are not currently globally relevant-their walled garden ecosystems are restricted to their own or certified partner devices. In today's polarized world, governments and military deploy wireless devices that are “imprinted” by them and use ground truth-trusted sensor-based verification, e.g., biometrics and GPS. Trusted Platform Modules and Protection Rings protect PHY radio interfaces via trusted device drivers on ring 1 to securely access PHY radios in kernel space-with wireless serial modem drivers interfaces to userspace apps.

Similarly, Enterprises and Regulatory agencies run on Clouds (servers). They expect authenticated information from their edge assets. MAC Spoofing man-in-the-middle attacks, are increasingly relevant in a polarized world where Huawei is boycotted in the U.S.—we mandate ground-truth veracity. Device level veracity—whether running on phone apps, silicon or AI cloud agents can only be assured when PHY to PHY link layers have tamper-proof handshakes—see Ser. No. 13/627,883.

Getting away from a MAC-centric scheme is rethinking the internet of things from the cloud end—this implodes the design space of Edge->Cloud challenges, FIG. 53 and shifts our thinking towards sustainable global solutions—where edge assets in remote, harsh, hostile regions or developing countries become manageable. Satellite level granularity is supported by small, dumb cheap sensor patches (described later) that provide time-series synced data streams from multiple sensors on the sensor patch for analysis in the cloud and fog.

In a MAC-less world, Cloud Orchestration removes MAC-ID based CSMA/CA and DCF from last mile power-constrained devices. Software-defined networking sets schedules and channels to remotely manage collision avoidance in time and spectrum. Shared data sets across federated clouds feed symbiosis. Emergence—cooperation of unlike kinds—is engendered because messages cross previously walled garden boundaries to provide new, corroborated intelligence, FIG. 9, 35-44.

The Cloud→Propagator→Edge shift from MAC heavy Edge→Cloud thinking simplifies the last mile and moves the intelligence and power consumption to Propagator and Cloud.

Imprinting makes chirpers lightweight and trusted. Consider then, in this Cloud→edge thinking, all software defined radios support device abstracted chirp protocols in addition to MAC heavy incumbents. Especially given radios that support simple UART-like modems. Next, see FIG. 3, 5, 14, 45, 47,—chirps from radios piggy back on existing networks. Thus an Apple Airtag in lost mode chirps within an iPhone community, but chirps are now also detected and forwarded within an Amazon Ring-based network—the two devices and their networks have been opted-in to a larger logically contiguous friend-to-friend cloud, FIG. 53. Thus both networks are interchangeable at any hop of traceroutes—more redundancy and range. Bi-directional chirp containers, FIG. 3, 14, 47, deliver bulk (for chirper species) and also chirper-instance messages.

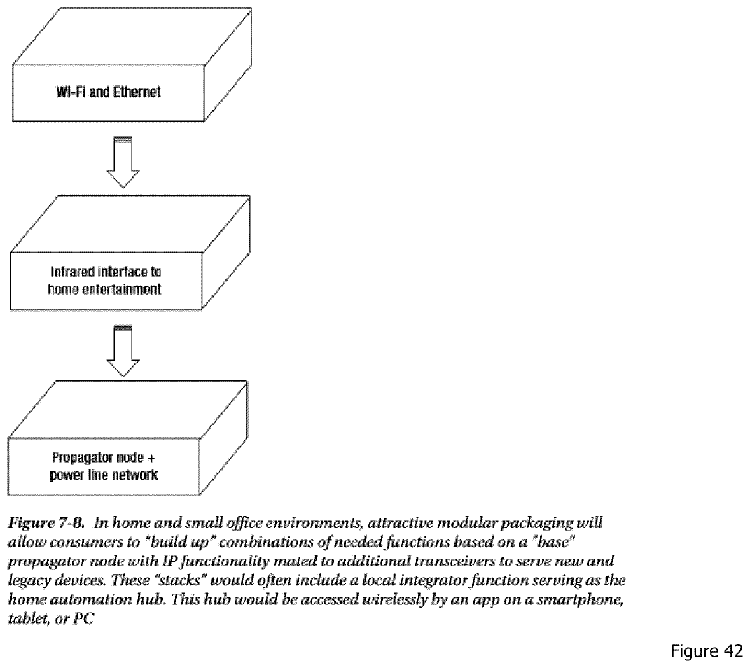

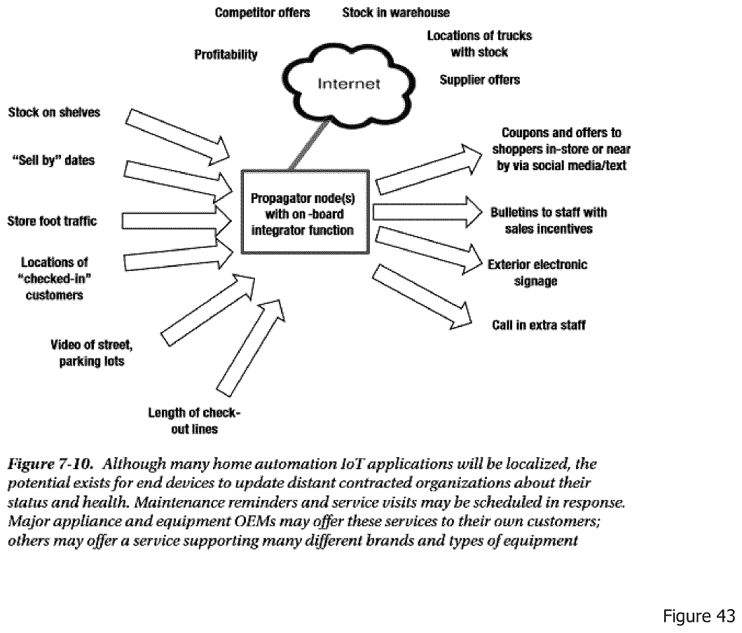

Data logs from co-located regions and species corroborate each other FIG. 7-9—Insights gleaned across many networks, devices, and protocols. Thus, Chirps intended for MAC-less devices may also run on MAC-based radios & transports as supplementary messaging and also for security—Chording and obfuscation techniques taught in Ser. No. 13/627,883.

Ser. No. 13/571,294 and Ser. No. 13/627,883 jointly teach Software-defined networking extensions for types of wire-less devices to proactively segment collision domains in RF and time, simplifying last-mile connectivity. Consider then a messaging overlay provided by Amazon, etc., hosting global scale enterprises, with remote assets in co-located regions, sharing sensor data, pooling in their opted-in devices and propagator network to provide a trusted enlarged network. Thus, Amazon

Sidewalk devices may accept messages from trusted devices, such as imprinted messaging. Further, all opted-in phones, tractors, cars, drones, and Amazon trucks may support multiple chirper frequencies and thus provide wide spectrum connectivity for community services insights for surveillance, tracking, and maintenance.

Chirpers, minimally a modem and MCU module chipset expressly for hosted edge→cloud messaging are provided as add-ons to enterprise assets. Amazon, etc. services imprint Chirpers per hosted Enterprise-defined Chirp-ID taxonomies. Hardware PHY is secured by trust-zone firmware—the hardware protects the software and vice-versa. Shared cloud services then become contiguous, FIG. 53, based on this PHY level authentication, enlarging both ecosystems. Devices with wakeup sensors chirp whenever “family” propagators pass through—opted-in vehicles, phones, drones. Others may chirp on schedules and are picked up by scheduled drones or people logistics supply chains. This womb-to-tomb PHY+Imprint trust is cloud-birthed and orchestrated a global scale. Data sets of co-located sensors corroborate each other—Emergent behaviors. Globally relevant ecosystems are engendered by a shifting to Cloud→Edge thinking:

1. Replace or supplement spoof-able MAC-ID-like identification.

2. Shift legacy-based CSMA/CA and DCF from edge over to cloud/fog.

3. Leverage minimally intermittent globally ubiquitous connectivity.

4. Opt-in devices and networks then support Metcalfe O(n*n) scaling.

5. Engender symbiosis—insights from larger & corroborated data sets.

Chirp Logical Tree Architecture Toll/hop costs compromise at each layer of a distributed hierarchical control system and are directly related to layered neural networks and the balancing of priorities at each level of the neural tree to meet “customer satisfaction” scheduling objectives. This network topology informs shuttle service schedules, which are modified per changing mesh topologies; see references. As taught, Toll cost, hop cost, scheduling-together comprise metrics—when biased correctly, as in back-prop models—balance the compromise between throughput (effective data rate) and routing jitter and latency of transports supporting multiple network clientele. The biases across the layers guide where more compute resources need be dispatched within edge-fog-cloud communities. At the edge, they segment collision domains in time, spectrum and regions to ensure smooth traffic flows. The Cloud/Fog processes may be embedded in A.I systems supporting software-defined networking extensions taught. Chirpers with ant-like smarts are accurately also modeled in such hierarchical models FIG. 6, 45, 51. Thus the scheduled containers, FIG. 3, 18-22, 47, in Edge→Propagator→Cloud thinking runs on logically abstracted node topology, FIG. 24-29. Propagators—on userspace apps, Kernel space IFTTT rules, circuit-based logic—are always in the loop. Formats are temporal and cryptic, dissuading man-in-the-middle attacks.

The Birthing Process for Chirpers. We begin with the birthing of a chirper—the first imprinting. Wireless modem+MCU control units, made in millions, are preloaded with a public imprinting scheme, intended to be replaced by enterprise-defined imprinting via hosted cloud orchestrator, FIG. 45, 55.

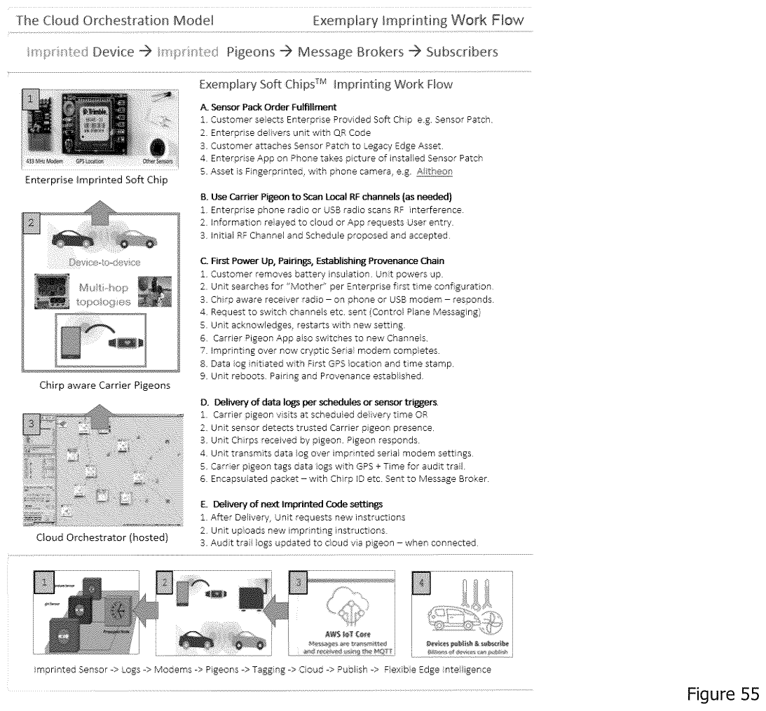

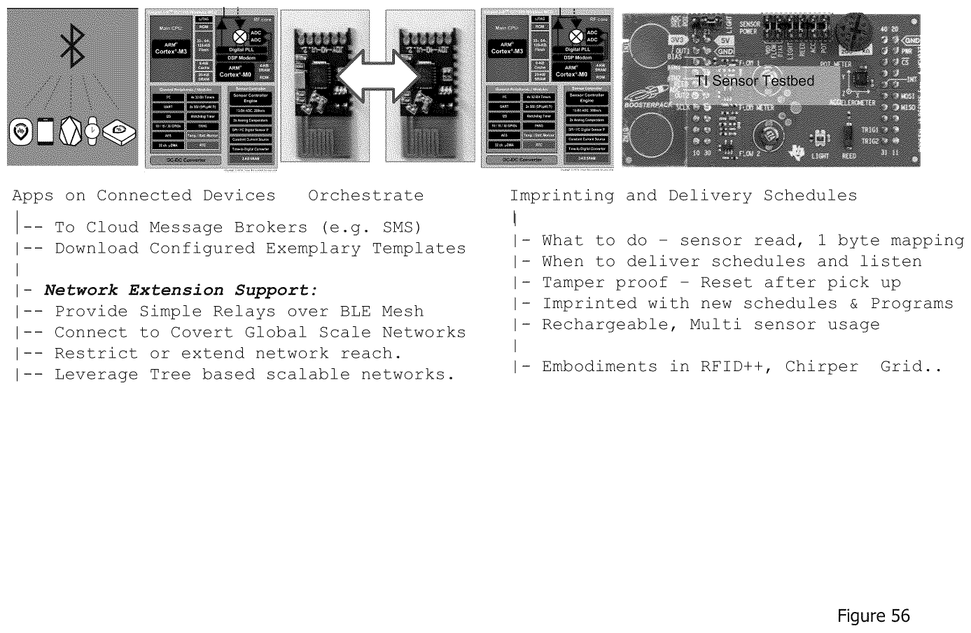

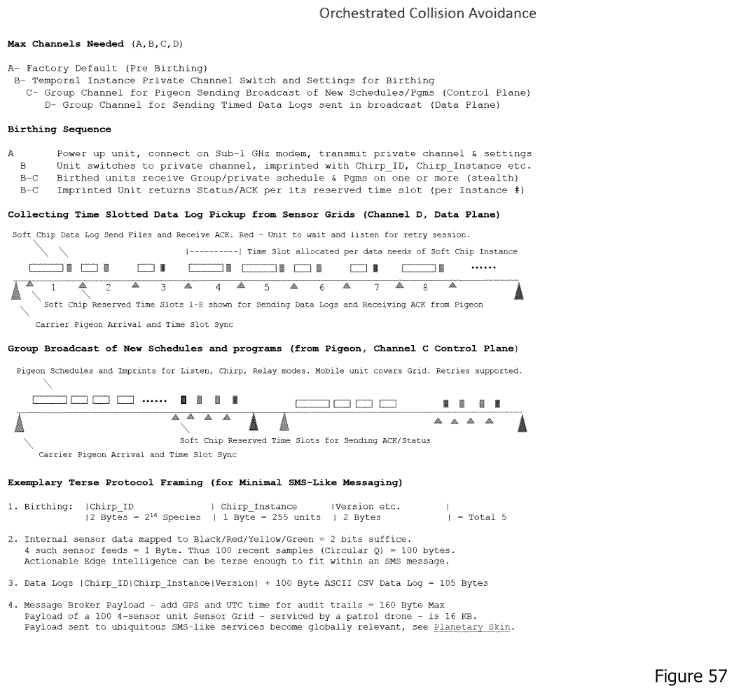

Example: The unit is a 433 MHz PHY radio modem, No MAC, MCU and sensor inputs, FIG. 15, 36, 39, 40, 41, and wake-up sensors. The first power-up is via public legacy-supported UART modem protocol. The unit searches for a modem on a public channel. The loaded sequencing code is Ladder Logic or IFTTT or circuit-based. “Chirp Logic” is schedule-based—When-this-then-do-that for protean modalities Chirp, Listen, Relay, can be replaced by enterprise-specific code and protocols.

|- DO

|-- When Schedule for Listen then do {Listen-Action}

|-- When schedule for Chirp then do {Chirp-Action}

|-- When (schedule for Relay then do (Relay-Action)

|-- When schedule for new-tune-pattern then do—

|-- When Schedule for Imprinting, Control plane-like configuration then—

|- UNTIL When {List of Termination-Patterns} then do {Termination Actions}

When {Pattern} then do {Action} where Pattern is any time based or event based—as in sensor driven or rule based—condition that fires—e.g.

a. when in time-window 12:00-13:00 do—chirp every 10 min then stop.

b. when in time-window 12:00-13:00 do—listen for propagator to arrive

c. When a heat sensor fires, do chirp “Fire!” every 10 seconds till stopped.

d. When “Fire!” is heard on a listen channel/schedule, relay it to others.

e. When the propagator is sensed or scheduled to be within RF range, then chirp.

f. When I start chirping, wait to hear if it is received by others, then go silent.

g. When taught to listen for carrier pigeon arrival, listen every 10 secs.

h. When told to be re-imprinted, unlock the protected microcode on the chipset. Reboot.

The UNTIL condition serves as a Non-Maskable interrupt (NMI) for private sensor or user input sequences. The firmware, while simple, is extensible.

The propagator→Chirper flow for imprinting in FIG. 2, 3, 6, 16, 21, 45 is from protected storage on carrier pigeons to protected storage on chirpers, see Chirp_Primer_Slides and references. Broadcasts-Chirpers have no MAC-but the payload is undecipherable, like pollen. Further, a container is sent, and chirpers extract what is relevant. Framing can be private.

Enterprises may choose from templates and sample microcodes developed by the IIoT community that mate components, FIG. 15, 32-44, for diverse product-market fits.

All chirpers use minimal broadcast (wire-less) transceivers, delegating most timing, channel selection, and packet framing to cloud mothers. Thus, chirp logic, as long as the timing is synchronized (see methods below), satisfies. The protean vocabulary—[Chirp, Listen, and Relay] suffices to build ant-like automata: When-woken-up-then-Listen-for-chirp-on-settings-A-and-repeat-it-on-settings-B. These may be imprinted in silicon (tamper-proof) microcode, userspace apps for diverse imprintable devices supporting DRM, or Trust Zone-like protection for the imprint section—think control plane—with other schedules part of the data plane. Data plane schedules are temporal and specific to each chirper—per segmented time/space collision domains—so they are not worth hacking.

The Configuration Process for Chirpers. Chirper modules that were generic may now be further branded with two static tags: Chirp-ID, the species of bird, and a GUID static tag like RFID/OCR/Serial-Number—an instance of a species. Chirp-ID and its instance tag may be further tagged by time/place by GPS on propagators—sufficient locally unique topic-based addressing for messaging, FIG. 16-21.

1. Cloud Chirp Logic, Schedules→Propagator routes via Modem→Chirper imprinted 2. Chirper Runs Logic→Makes Logs, etc.→Waits/Listens for Propagator Arrival 3. Propagator picks up Logs→Propagator Tagging→Messaging→Subscribers 4. Chirper receives new schedules, time, GPS synchronizations→Cycle repeats.

Dynamic Data Logs. Imagine a supplier who supplements RFID/OCR tags with “RFID++” dynamic tag—sensor streams via BLE or Wi-Fi radios. This MAC-based sensor pack sends chirps blindly every minute. The payload is cryptic-it has 1/0 status bits for rough handling (accelerometer), refrigeration (temperature fluctuations), or suspect transit routes (GPS based). But the IP header is 4+ bytes. The BLE battery lasts a week. However, during transit, Chirps are picked up by shippers that read both “tags,” FIG. 46. Service Level Agreements (SLA) are thus verified. The RFID++ tag has served its purpose.

RFID+BLE→Periodic chirps->Delivered→Discard RFID+BLE Chirper.

Consider now a new product a non-BLE, non-MAC RFID++™ minimally low power Chirper and its purpose-built protocol birthed and imprinted by IIoT cloud services and opted-in by federated communities providing carrier pigeon and replaces or supplements RFID/OCR, etc.

1. Cloud imprints Chirper at birth→Private tunes/protocol established.

2. Chirper listens, receives broadcast messages on schedules and chirp patterns

3. Schedules Run→Chirper Makes Logs→Waits for Propagator→delivers logs.

4. Propagator Tags for Provenance→IP Gateway→Message Bus→Subscribers

5. Cloud changes schedules/tunes to be both obfuscated, terse, low-power

6. Community is federated and opted-in and/or regulated serviced by pub/sub.

“Community” is delineated by segmenting collision domains-schedules, channels, patterns, FIG. 3,45,47,49—from other co-located communities.

Broadcasts may be public—or private, and species and species-instance are flexible.

1. Cloud Public Schedule→Chirper←Propagator Broadcast←Cloud Mother.

2. Cloud Private Schedule→Chirper←Propagator “Email”←Cloud Mother

Secure Asset tracking: MAC-ID are spoofed-MAC address anonymization, third party sourced and unrelated to Chirp-ID which is specific to the Enterprise owning its assets and hence its data, without the need for third party certification with MAC-ID etc. Enterprise and partners—not trusted, OK—may now define their own data streams, FIG. 8-9, but also corroborate each other's ground truth sensors. Thus a package may have both RFID and RFID++ trackers. Service Level Agreements compliance is verified. RFID++ tags may also be add-ons to Legacy assets for womb-to-tomb Cloud→Remote Edge connectivity.

Global Scale Sensor Grids. Consider Demilitarized zones are not part of trusted networks and therefore, carrier pigeons (drones, vehicles, phones) are scheduled to be within RF range (earshot) to pick up warning chirps of intrusion. These chirps cannot be incessant for both power and security. In a cloud-orchestrated world, the cloud sets both the schedules for carrier pigeons picking up the data logs and when devices listen/chirp/relay, FIG. 2, 3, 6, 45, 49. Per Ser. No. 13/571,294, FIG. 54, Subscribers and their services know when bus shuttles must deliver within time window relevance. When data is consistently within safe control ranges, FIG. 49, sampling is reduced and conversely increased when transitions in control ranges (green→yellow→red) occur. Clouds drive when to harvest chirps from chirpers, per hop latency and toll costs along “best” trace-routes. They then imprint non-overlapping RF channels, chirping patterns, and schedules for logistics “circuits”—for the edge and for shuttle schedules. The cycle self-tunes, FIG. 6 from Ser. No. 15/908,108, also FIG. 48, 51, 54. Thus:

a. Subscribers set relevance time windows→Aggregation schedules for buses set.

b. Chirpers back scheduled to publish data logs→Carrier pigeons pick up.

c. Carrier Pigeons deliver to IP Backbone→Message Brokers→Subscribers

d. System toll cost/hop cost see FIG. 45. 24, 25 may change topology

e. Topology changes affect bus schedules, system iterates, FIG. 6, 45.

Thus a chain of events drives propagators to schedule shuttle buses that containerize packets, and predictable latency. That in turn, back-drives when chirpers chirp, listen or relay etc., based on edge resource constraints and network conditions, FIG. 45 from Ser. No. 10/434,948. The framework is iterating at many levels as a distributed control system interacting with data flows from edge, fog, and cloud, which are familiar terms to those practiced in art.

Example: 10 intrusion detection sensors in a DMZ zone sense/listen (not chirp) every 1 minute, thus internally collecting 60 samples/hr. The chirp packet is 2 bytes—the chirp payload is 120 bytes/hr.=2880 bytes/day. The control system requires packets every day from all 10 sensors=28,800 bytes/day. It sends out a drone with a trusted USB powered chirp receiver radio modem and propagator software to pick up this container daily—the carrier pigeon and propagator as one unit. It delegates one of ten chirpers to be also an intermediary for all 28,800 bytes to the daily carrier pigeon. The chirp broadcasts from modems are tagged FIG. 16, 17, 18 for IP routing when the drone returns to the military base. The Backward Scheduled Logistics supply chain may be:

1. Packet needed daily 12:30 PM for Surveillance control system sampling.

2. Packet routing from pickup phone/drone to base travel time is 10 min.

3. Packet pickup from chirper relay to phone scheduled 12:30-00:10=12:20

4. Chirper relay node to get all sensor packets scheduled worst case=12:15

5. Nine chirper each deliver 2880 byte packets to chirp relay node by 12:15 PM.

6. A staggered chirp schedule is imprinted for nine sensors: 12:00, 12:01, etc.

7. Relay imprinted with listening and store schedule from Chirpers, 2,880 each.

8. Relay has aggregated 28,880 byte chirp container ready for pickup 12:15.

9. A drone or phone with USB radio modem visits and picks up chirp container.

The 28,880-byte daily chirp container is now on the IP backbone. Apps on phone/drone/routers are minimally intermittently connected to the cloud-they forward to one Amazon web service (unicast) or many subscribers (multi-cast).

A variant of early warning system grids is to aerial seed a region with sensors FIG. 39-40 to measure or send alerts in case of fires, flooding, etc. The region is seeded as a grid and chirpers sleep mode till it senses heat or flooding and then begins chirping till told to stop. Each chirper may be imprinted with randomly staggered or prime number-based intervals—see references—to listen to fellow chirpers and relay alerts—thus news of the fire/flood spreads quickly without collision and reaches a patrol drone or connected base unit (root node). Thus, these sensors are running two programs concurrently:

a. Chirp Sensor→Sleep till sensors or alerts wake me up→Chirp till stopped.

b. Also Listen for Chirp Alert→Relay→Reach Connected Devices→Stopped.

Chirper Payload Constructions—previous methods taught to keep payload short for both power, detectability, and security are revisited below.

1. Device circuitry may be imprinted to only chirp. A variant would be a device that chirps and also listens—optionally on other channels—to serve as a relay—also optionally on other channels. A device may listen for carrier pigeons within an ETA window and chirp only if pigeons arrive. Less power→longer life.

2. To minimize addressing space, topic-based cryptic, locally distinguishable CHIRP-ID defines the local digital bird species. Example: 1 byte identifies 255 different types of chirpers operating on the same channel and within RF range of each other and at the same time windows—concurrent collocated operation.

3. Cryptic payloads reduce power and detection. Thus, GPS enabled Chirpers may receive the locations of the relay node and compute a relative “vector”—a terse message. This “vector,” may be expressed as smaller quadrants every 2 bits—e.g., from top left, 00,01,10,11. An 8 km region is then monitored by 256 sensors in 16×16=256 1/2 square-km. grids, cryptically as 00000000 (topmost, leftmost) to 11111111 (bottom, rightmost)—all within 1 byte for ½ km-square granularity grids. Similarly, directional vectors can be expressed in N/S/E/W.

4. Quadrant mapping for temperature, etc. may also be granularity based. Thus a Chirp_ID+Time+Temp+GPS data may be 1 byte Chirp-ID, 4 bits for 24-hour clock mapped to 2-hour granularity (0000=15 variations, 12 needed), 4 bits for temp, same logic, 1 Byte for GPS=total 3 bytes per sample every 2 hours. Payloads may be further cryptic to be status indicators as taught-red, yellow, green or black (dead). UART protocol's overhead is 1 byte (12 bits (1.5×)). Transmission over serial modem (including stop/start/parity)−for 12 samples a day*3 bytes=36 bytes daily→1.5*36 =54 raw serial modems daily or 1620 bytes monthly. Red/Green/Yellow/Black may be expressed in 2 bits (00, 01, 10, 11); 12 samples are 12*(2/8)*1.5=4.5 Bytes daily.

5. Each chirper, after tagging, may also use “community mailboxes” on the IP backbone side that Propagators can access via DRM for a protected transport to the protected storage in the Chirper device—see Trust zones on ARM chipsets. The Chirper cannot directly access them—intentionally not IP enabled and hence impervious to man-in-the-middle attacks. It is also trusted because propagators do audit trails by tagging, FIG. 18-21. Mailboxes may thus store directives to individual Chirpers in this Edge→Pigeon→Cloud model, FIG. 1. “Emails” back and forth from propagator to thin connectivity Chirper. Device-authenticated apps (WhatsApp, SMS) may also be used, provided they have access to the PHY layer of chirper—e.g. through a USB modem and certified chirp device driver access. Thus, Userspace Apps may receive status heartbeats from chirpers (“small data”).

6. Synchronized Timing may be managed by including a GPS unit or synchronizing the time when the carrier pigeon arrives and broadcasts on the public channels. This is, in effect, a “Synchronize-your-clocks” message. It is also synchronized across chirpers, and they can adjust to each other within communities. Further, southbound shuttles (cloud to edge) provide offsets computed from counter numbers in data logs that don't match—if all chirpers provide daily logs then daily timestamp deltas should be identical. Time drift etc., is corrected. Cloud→Propagator→Edge flow includes devices with GPS+time to synchronize at each encounter.

Synchronized Time series of sensor data also enables quick correlations and inferencing. Thus a sensor patch comprising of multiple sensor streams may display interlinked correlations such as damp plus dark favors mold growth. Further, individual sensor streams And derived inference streams may be quantized into red, yellow, green, and black (inactive) reprogrammable RGYB values, expressible in 2 bits. The raw data streams and inference streams are akin to DNA intelligence embedded in the correlations. This digital DNA may then leverage the existing tools for genetics and derive new interesting inferences from a non-silo-based approach to sharing information across the fog (distributed cloud). Thus, apps on phones operating in 2G spectrum may, as carrier pigeons or propagators, participate in the benefits of Globally Scale sustainable IoT.

### Exemplary Collaborative Workflow

Multipurpose sensor patches may have GPS, accelerometers, temp, and pressure sensors preloaded but not activated without protected imprinted microcode or chipsets. While each “Species” may have its own walled gardens as in consumer e.g., Apple, Amazon, Google, but—to expand their reach collaboratively-may also opt-in to allow their networks to become logically contiguous, FIG. 53—propagating chirp messages. Thus, a chirp to an Apple BLE phone is relayed to an Amazon Ring and to a Cisco Wi-Fi router to an Amazon Hosted Cloud Service. Such services may also provide Sensor patches—a roll of 1000 patches that contain sensors (GPS, microphone etc.) that can be imprinted and attached to machinery to provide customizable—and reprogrammable edge intelligence for predictive lifetime maintenance of all types of assets, mobile or static. Since Amazon hosts multiple enterprises, regardless of fractured radio frequencies and radio protocols, their chirp species can now discover and detect others based on cloud birthing-imprinting and cloud-managed pub/sub access.

Beyond Amazon Sidewalk: Consider heat sensor+GPS units aerially seeded in forests. They are silent until activated by heat. They listen periodically on an SOS channel and pattern—e.g., once every minute, based on GPS-based timing—synchronized. Also, consider a simple staggering scheme e.g., prime numbers (3, 5, 7, 11) to address latency and some jitter for deadly embraces. Thus, the first chirper and relays are effectively “polite” without the need for complexity—the first is once every 3 seconds (and this can be measured), so the next is 5 seconds. Jitter ensures that at 15 seconds out, the ⅗ sec chirps are not colliding directly. The relay now provides GPS of fire and the number of hops away, based on periodicity (3/5/7).

Exemplary Soft Chips Work Flow-See FIG. 55. Cloud-generated Stickers—with QR codes—are shipped and applied to the asset. Soft Chip is registered and imprinted via smartphones and/or a supplied USB wireless modem or BLE connection. Workflow is entirely customizable to provide high resolution and dynamic sample rates on an on-demand and on-time basis.

Logistics Applications: the sensor patches or tags are shipped to a consumer or enterprise for their asset tracking. The tag may have GPS and the usual sensors and be rechargeable and re-imprintable via USB or Solar. When the battery insulation is removed, it will search for the mother—the network of trusted propagators that can imprint it. After imprinting, units may then provide womb-to-tomb machine prediction analysis based on the sensors and Machine learning logic in the fog. New apps are written based on the behaviors learned from the assets. Thus, a microphone now listens to audio tunes from a pigeon and is also now taught to detect other salient signals—noisy machine bearings→need oil→alert maintenance.

### Soft Chips Minimal Viable Products Using SMS (See FIG. 56)

A minimally viable Soft Chip workflow may use SMS as a message broker and BLE/USB on pigeons to store and forward. See Chirp Primer Slides referenced for more.

Consider a potential use case for a farmer in rural Africa. His phone has no connectivity in the field where the sensors are. A store and forward mechanism is needed—see this email-based thin device for rural distribution chains. We also want to leverage SMS like free messaging services so we must limit the total payload to 160 bytes for SMS transmissions. There will also be tagging at the Smartphone application end before it is transmitted to SMS message brokers—when the farmer has connectivity. We thus further limit data log payload to be no more that 110 bytes, with 10 bytes reserved for Chirp-ID, etc. The 100-byte data log will be sent on SMS, so we may further restrict it to ASCII and CSV-like format.

For the 100 bytes payload (the data log), our options are based on how many samples and each sample size in bytes:

#Samples: Sample_Size_in_Bytes:

100:1, 50:2, 25:4, 20:5, 10:10, 5:20, 4:25, 2:50, 1:100 (100 each).

Thus four sensors, each providing 1 byte may be sampled 25 times during pigeon pickup sessions. This specific Chirp payload framing is thus fleshed out to be 25 samples of |Sensor_1|Sensor_2|Sensor_3|Sensor_4|=25*4*1 bytes. This is generous because 2 bits (0 through 3) define “black or dead”, “red”, “yellow”, “green” mapping to programmed sensor data ranges. Thus 4 sensor feeds can be condensed to one byte (8 bits). Edge intelligence can be terse yet meaningful-especially in receiver-oriented communications. In stealth uses for mobile asset tracking and intrusion detection, 1-2 bytes & no Chirp-ID (obfuscation) sufficed.

When pigeons arrive, data logs are transferred based on handshaking supplied in the imprinting protocols—and could be as simple as an obfuscated version of Chirp-IDs. Recall schedules and protocol framing are private and can be changed each trip—using temporal keys and frequency hopping.

After data logs are delivered, the data log is erased, and effectively a soft reboot begins the next data logging schedule—which may include a new programs or framing. The soft chip may not have GPS to conserve both cost and power, but pigeons may sync location or use triangulation methods. Mobile asset tracking at this level of granularity may suffice for perimeter surveillance. Similarly timer counters can be synched between pigeon and sensor units and later mapped to GPS/Time when the pigeon delivers data logs to phones for SMS.

The farmer transfers the data log (110 bytes) from the pigeon to apps on his phone with BLE pairing between his phone and the BLE radio on the pigeon. Or uses a USB modem. The phone app can add GPS and time stamp tags and eventually forward them to message brokers, such as SMS, WhatsApp, etc. These trusted community networks may include oversight agencies that rely on remote ground data to drive forecasting and other functions.

A minimal viable—and self-sufficient—product emerges, which may also leverage existing BLE connectivity, already in use for indoor IoT to connect with BLE mesh on local WLANs. The farmer's phone may thus use other phones in the network to connect to cloud services.

Consider now two WhatsApp accounts on the phone. One is admin-protected and provides programs and schedule templates. The phone app adds jitter settings so soft chips avoid collisions and generates new imprints for all Soft Chips on the farm—a poor man's Cloud Orchestrated Model. The pigeon-like postal workers—carries community “mail” and distributes it. Data logs from soft chip grids, collected through the region, are sent to another SMS or WhatsApp account to collectively provide actionable intelligence available to digital and human subscribers—operating at a globally relevant scale. Thus, two messaging accounts, an intermittently connected device, and store-and-forward pigeons support dense sensor grids relevant to food supply, climate preparedness, asset tracking etc.

On-demand data collection services are now possible at a low cost of deployment with phones and SMS and leveraging artificial intelligence in carrier pigeons or phones. Thus, a phone or drone can traverse a large area on a scheduled basis or on demand, thus providing flexible, customer-driven data collection services within time windows of relevance. In many unstructured environments, Conventional Connectivity e.g., Cellular or wireless mesh—are cost prohibitive and not globally scalable or sustainable. Just as courier services cover even rural areas, so also similar infrastructures using phones cars and drones may provide services for remote IoT Cloud services.

The digital DNA fabric thus described Leverages ubiquitous intermittent connectivity. At a global scale. Using all available methods provides intermittent connectivity with edge devices with a simple yet powerful encryption scheme. Trusted friend to friend to friend logically Layer 2 contiguous meshed network of propagators service edge to cloud connectivity. The network is preferentially a logical network tree with order, N Log N for scalability and distributed hierarchical routing functionality. At these nodes or branches of the abstracted network, publish and subscribe Shuttles run in a cloud-orchestrated edge-to-cloud ‘mother-child’ relationship—secured via imprinting and reprogramming of updated services required. The edge is now evolving in lock step with dynamic subscriber demands for ground truth verification driving global scale decision support systems operating at any of the branch nodes in logical or physical proximity e.g. satellites, robotic vehicles human-operated cars, phones, routers, gateways, hubs, private networks, etc. These new edge devices use lightweight terse receiver-oriented messaging to communicate securely within scalable pub sub-communities. Edge devices also no longer have to support bulky IP-based protocols or heavy encryption because the languages are like bird warnings-terse and cryptic. Costs and edge energy consumption plummet with the scalability and re-program ability of such simple yet elegant modem-based edge devices at the nerve endings that form the digital DNA Fabric of the new age of machine intelligence and its evolution.

The digital DNA fabric: it is comprised of minimally a receiver-oriented messaging system that incorporates Nature. It is based on imprinting schemes as part of both end-to-end encryption and communication from protocols. Thus, the enigma machine would not have been broken had it not been for recognizing a chirp tune, specifically a mandatory greeting to a wartime leader, that was being used as an end-of-message “tune.” The codes were changed every day, as were the imprinting schemes on each pigeon visit in the Digital DNA fabric. Thus, the ability to securely adapt and reprogram edge devices in alignment with dynamic subscriber interests. This is akin to organic DNA with its cryptic ACHT like RGYB sensor indicators in a synchronized time series. To stop viruses from spreading throughout the nervous system is best managed through a logical tree-based structured meshed network.

In one embodiment, the system seeks to distribute energy equitably. All entities require access to energy, such as organic life forms, chemical processes, and participants in digital systems. In the physical world, devices on the edge of the ecosystem or the network are more energy—constrained because participants near the center control energy distribution, and their access to energy is required to maintain the system. Nature has evolved systems to deploy cryptic receiver-based transmissions in the natural world for scalability and sustainability. Natural systems are data efficient but are not necessarily equitable in distribution and use of energy.

In a cloud orchestration model, the current network connectivity to the edge is provided by a plethora of propagators operating within a shared information structure. Routing patterns are defined to support the imprinting and data retrieval tasks that need to be completed based on energy availability and previous energy drains at particular endpoints. This minimizes the energy needs of low-cost and simple edge devices and promotes the widespread use of devices on a scale of billions. The evolutionary wireless network teaches how the propagator networks and their shuttle busses achieve the scheduled or event-based data delivery to the edge. In this way, routing patterns are designed to prioritize tasks and data retrieval based on energy availability and historical usage. This helps prevent excessive energy consumption at endpoints, promoting inclusivity for low-cost and simple edge devices.

Economies of scale drive power hungry AI forward cloud orchestration systems to collect increasingly larger data sets at global level and scale. Such a dense nervous system mandates multiple and diverse multi spectrum sensor nerve endings to provide corroborating ground truth verification and audit trails. This limits the AI hallucinations to where cloud agents reside, and the agents are distributed as parts of an existing IP network of routers, pigeons, propagators, running in a shared space of pub sub and receiver-oriented messaging.

Further, as with human experience, using cloud orchestration, the data sets required by the edge may be culled to be limited to the minimal set of corroborating independent variables (data being provided by sensors) to confidently infer the symptoms on a case-by-case basis. For example, the presence of mold can be inferred from readings indicating an environment which is dark, damp and includes limited air exchange. Three sensors (light, air motion, humidity) may be sufficient, without a dedicated sensor for mold. The remaining three sensors have broad applicability, unlike a dedicated mold sensor.

By leveraging AI, this digital “experience” is learnt independently by the AI systems. A cloud orchestration system now activates those three sensors of the multi sensor patch. Over time, the

AI systems energy at the edge is minimized because only essential sensors are activated and the chirp speak evolves to be terser and situation specific.

The cloud orchestration model allows for maintaining energy equitable distribution when assigning tasks and during data collection and analysis. The usage of all resources: energy, network bandwidth, subscription and publish groups and their bus shuttle logistics is all managed within the cloud orchestration model that thus is scalable efficient and sustainable.

### Synopsis

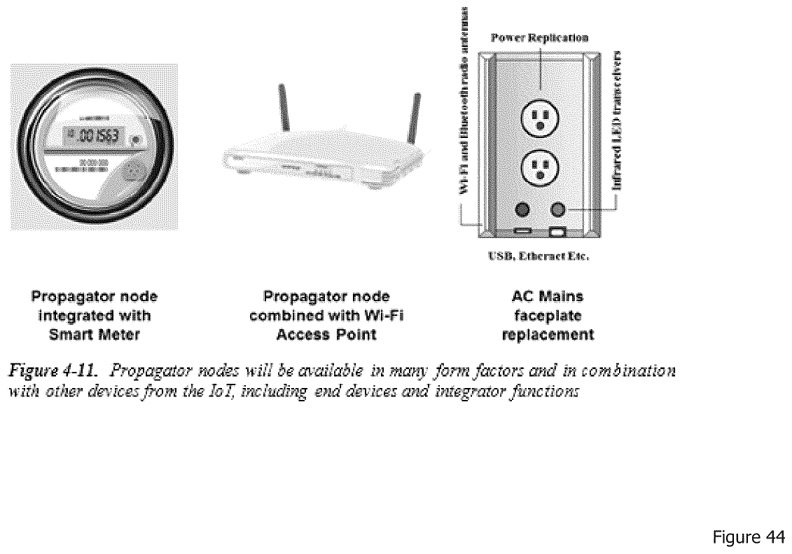

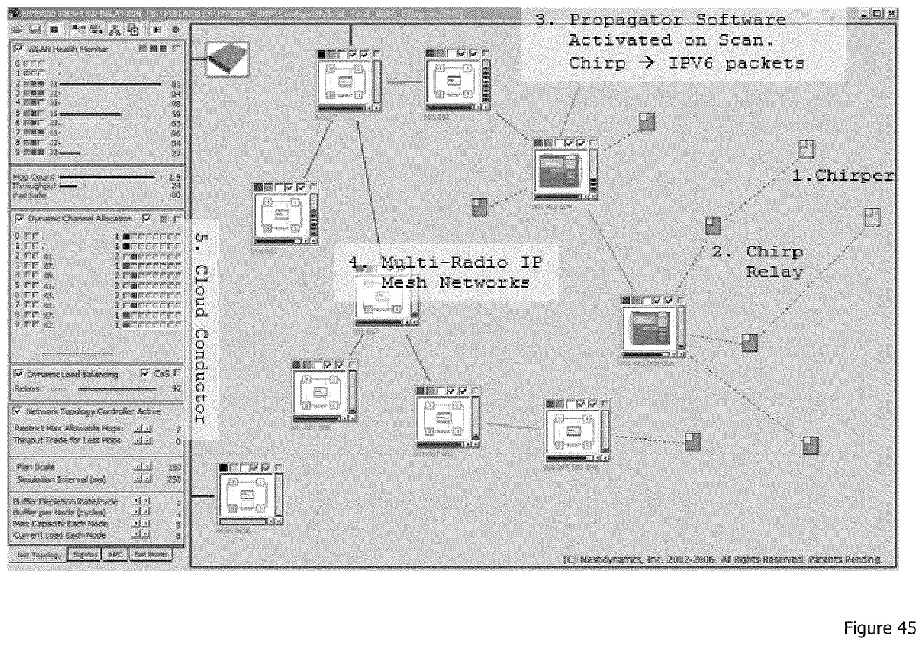

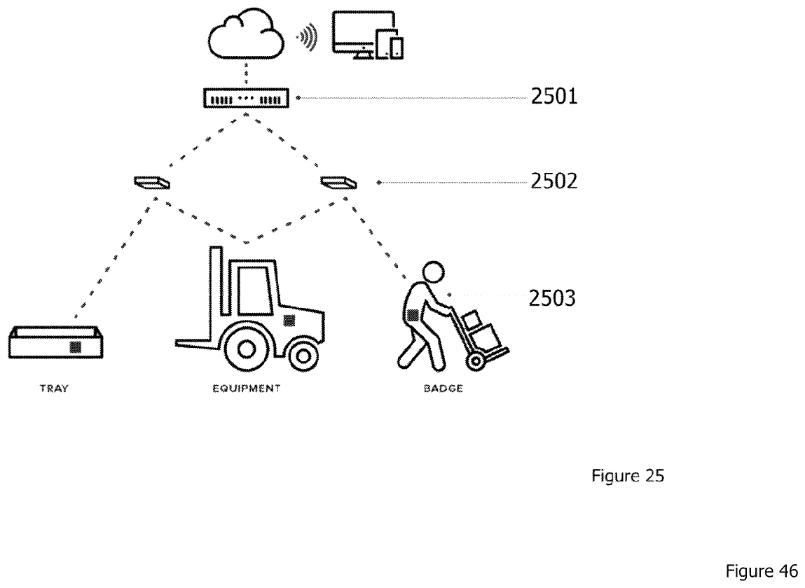

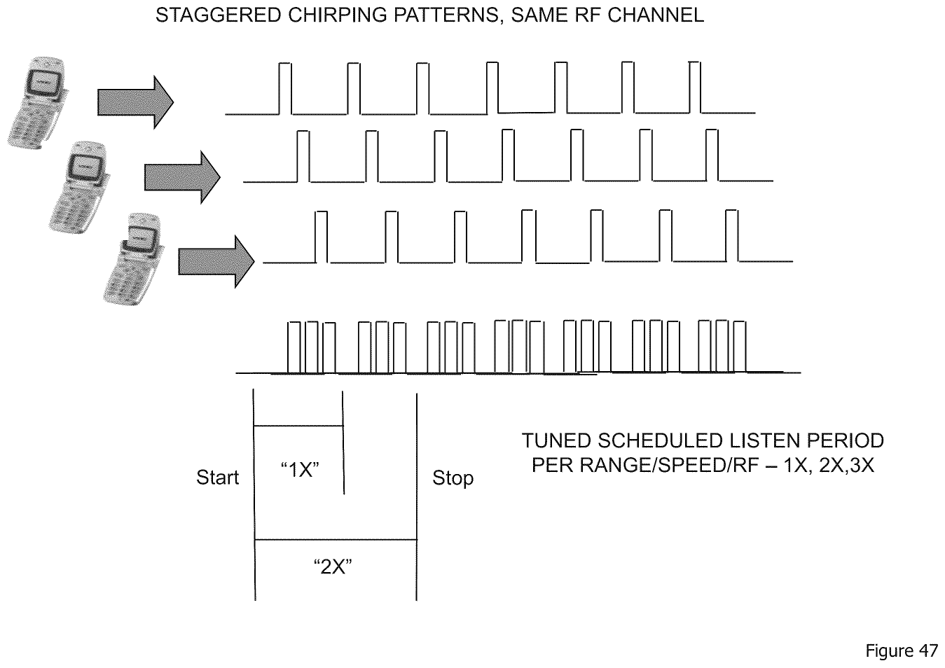

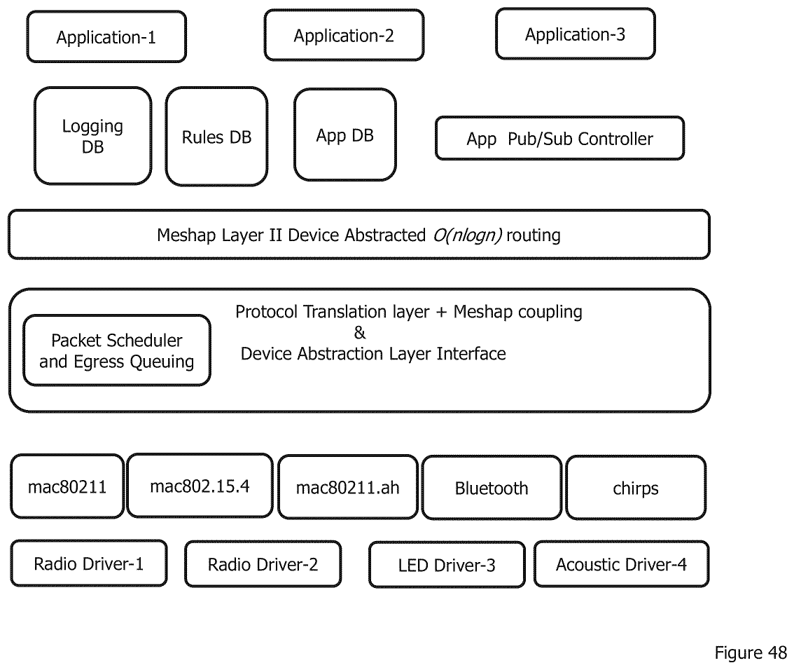

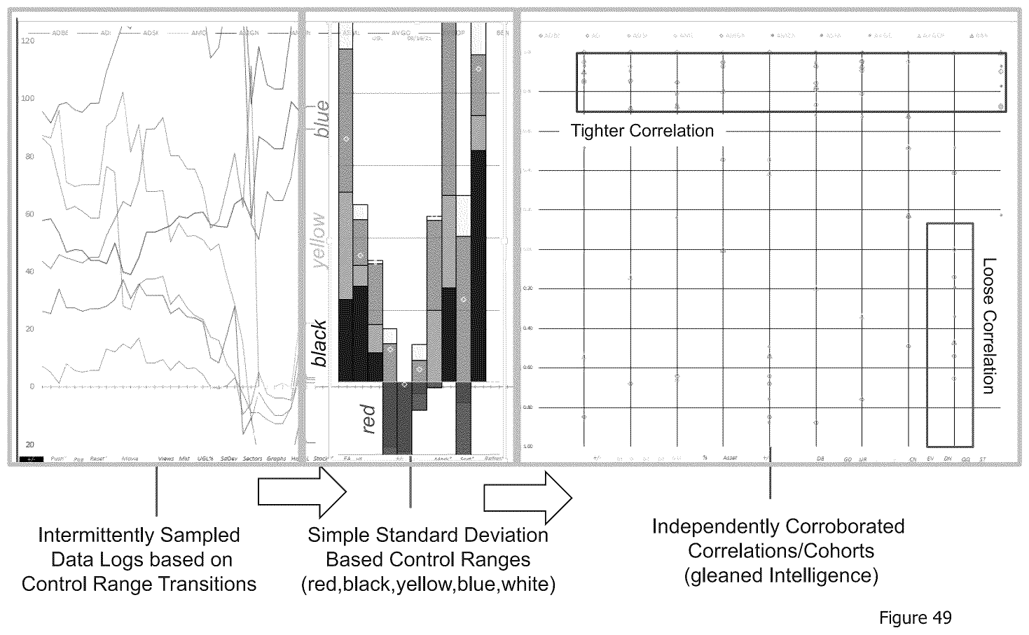

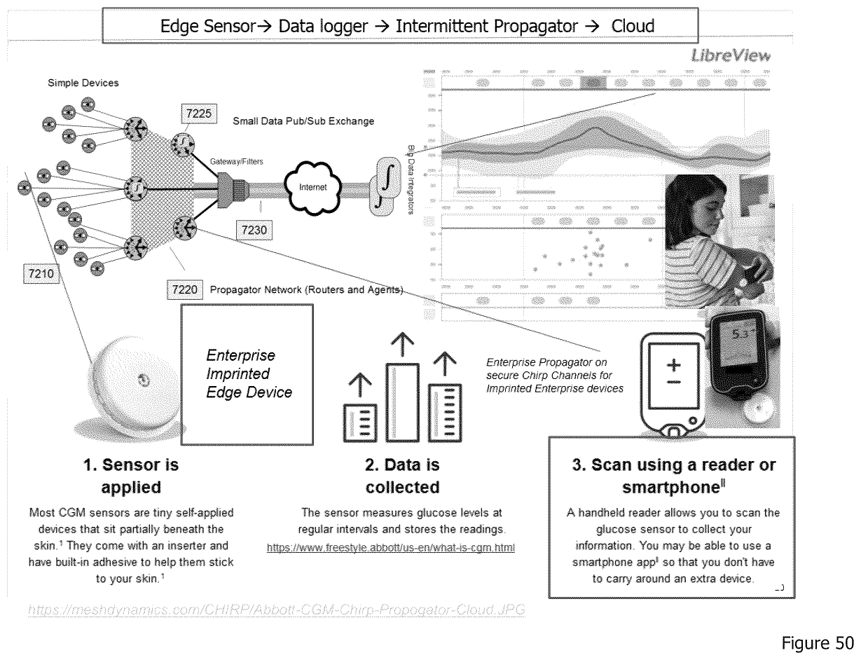

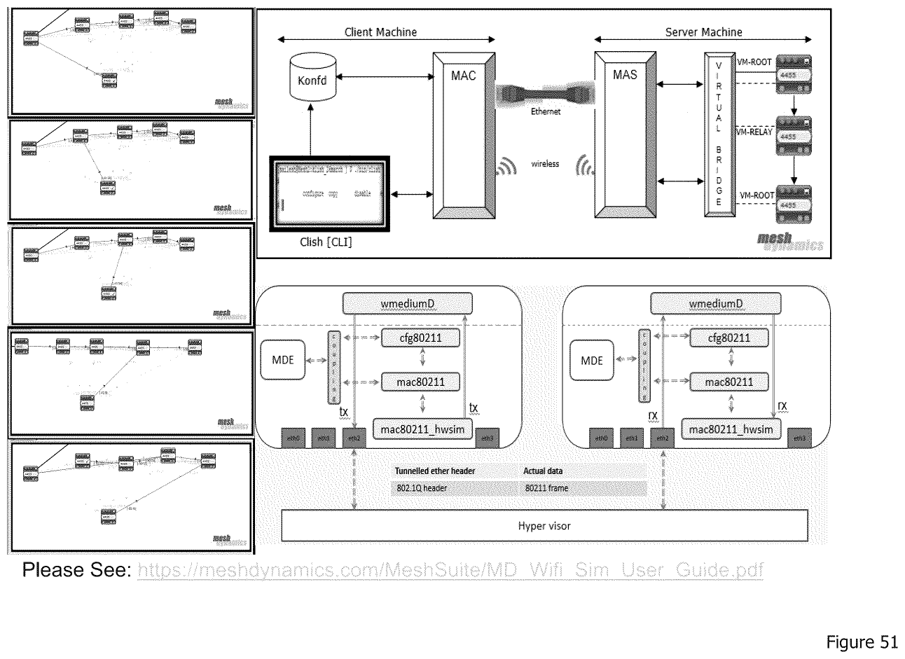

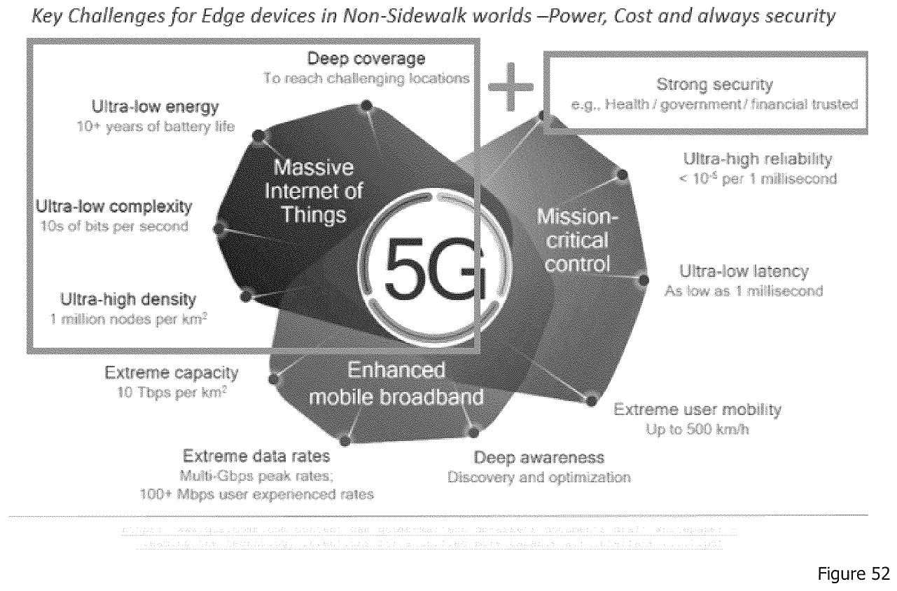

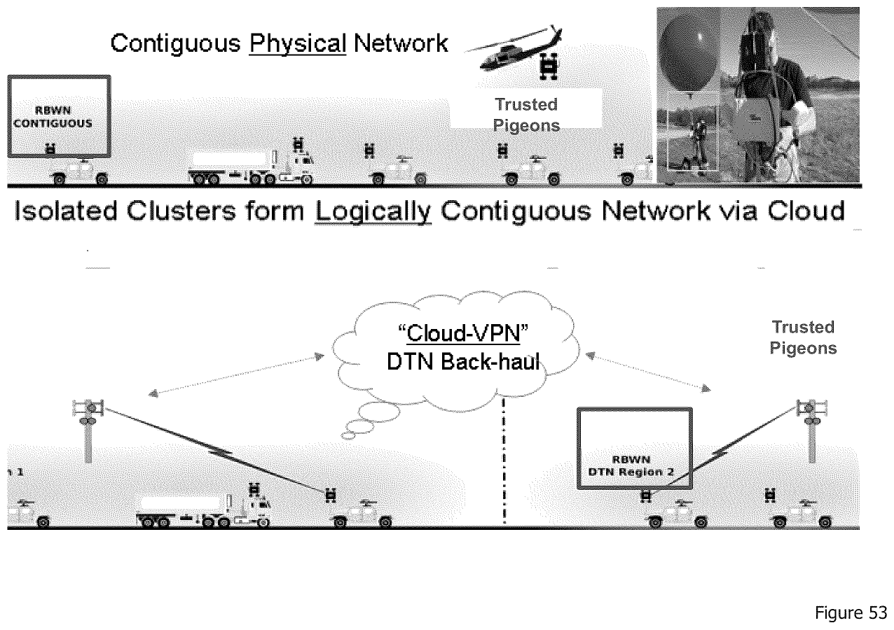

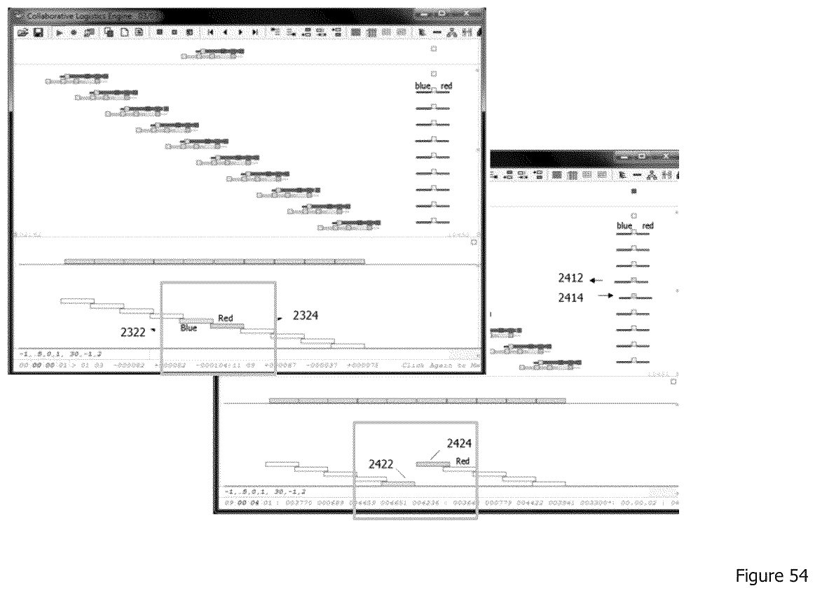

We present a globally relevant Edge→Cloud receiver oriented, innately secure, cryptic messaging protocol and architecture for globally ubiquitous, minimally intermittent, best efforts, thin connectivity. It is zero-trust and impervious to typical wireless man-in-the-middle attacks. It does not use conventional MAC-ID addressing or incumbent MAC protocols. These Thin devices acquire data and then transmit it on imprinted schedules, channels, and private patterns. Chirpers and Propagators may be re-imprinted. Over time, trends are inferred from correlation with trusted IIoT devices, forming a reliable emergent ecosystem FIG. 7-12, self-tuning—adapting to verified data from the “Edge.”

The key implemented features include planned and managed intermittent connectivity, which suffices for periodic sampling rates for many Edge IoT control systems with significantly reduced power, cost, and needless round-trip IoT traffic, FIG. 28,29. Data collection may be delineated from its scheduled delivery to the cloud or fog. Such intermittent connectivity solutions are globally ubiquitous, massively scalable, adaptable, resilient, and secure.

The future world of small, dumb, cheap, and copious sensors, actuators, and devices demands rethinking at both ends of the scale. At the far reaches of the network, simplified chirps will minimize lifetime costs for the myriad endpoints of the Internet of Things. At the same time, powerful networking and applications tools concentrated in propagator devices will allow unprecedented control and flexibility in creating massive enterprise networks of diverse elements by extending industry-standard Software Defined Networking capabilities. Fully exploiting the power of the Internet of Things will grow from a total rethinking of network architectures.

### APPENDIX

Table supports conjectures made on globally relevant Edge→Cloud challenges https://www.volersystems.com/blog/wearable-devices/inexpensive-low-data-rate-links-for-the-internet-of-things

TABLE 1
Power Efficient, License-Free Radio Systems or Standards

| | | Data Rate and | | Typical Tx | |
|---|---|---|---|---|---|
| Name | Freq Band(s) | Modulation | Structure | Power | Range |
| SigFox | 868 MHz, 902-928 | 300 bits/sec | Star | +15 dBm | 50 km outdoors |
| | MHz | BPSK, GFSK | (Tower | | |
| | | | and | | |
| | | | remotes) | | |
| NWave | 315, 433, 470, 868, | 100 bits/sec | Star | +20 dBm | 20-30 km rural |
| | 902-928 MHz | BPSK | | | |
| Symphony | 902-928 MHz | 300-50K bits/sec | Star or | +23 dBm | 8-16 km user on |
| Link | | | Mesh | | ground to tower |
| Ingenu | 2400-2480 MHz | 100 bits/sec | Star | +20 dBm | >500 km line of |
| | | DPSK with | | | sight outdoors |
| | | RPMA | | | |
| LoRa | 109, 433, 868, 902- | 300-50k bits/sec | Star or | +14 dBm | 10-20 km user on |
| | 928 MHz | Chirp | Mesh | (EU) +27 | ground to tower |
| | | | | dBm (US) | |
| Waviot | 433, 500, 868-915 | 50 Hz BW | Star | +20 dBm | 50 km outdoors |
| | MHz | | | | (tower/tower) |
| Thread | 2400-2480 MHz | 250 kbits/sec | Mesh | +10 dBm | 30 m indoors |
| Zigbee | 868, 902-928, | 20-250 kbits/sec | Star or | +20 dBm | 30 m indoors, |
| | 2400-2480 MHz | BPSK and | Mesh | | 1500 m outdoors |
| | | OQPSK | | | |
| EnOcean | 315, 868, 902-928 | 125 kbits/sec | Mesh | +10 dBm | 30 m indoors 300 |
| | MHz | ASK or FSK | | | m outdoors |
| 6LoWPAN | 169, 433, 470, 868, | 250 to 4M | Mesh | +16 dBm | 5-10 km user on |
| | 902-928, 2400- | bits/sec ASK, | | | ground to tower |
| | 2480 MHz | BPSK, O-QPSK, | | | |
| | | DSSS, Chirp | | | |
| Z-Wave | 868 MHz, 908 | 10-100 | Mesh | 0 dBm | 30 m indoors |
| | MHz | kbits/sec | | | |

1. A method for orchestrating chirp-based communication in a distributed network, comprising:
configuring edge devices with chirp patterns, channels, and schedules derived from at least one orchestration source;
segmenting collision domains in time, frequency, and spatial dimensions to ensure efficient and equitable use of shared communication resources;
utilizing propagator nodes to aggregate, filter, and forward chirp messages to cloud systems while preserving cryptic and minimalistic payloads;
adjusting chirp timing dynamically based on network conditions, application relevance windows, and power constraints.

2. The method of claim 1, wherein propagator nodes leverage multi-hop connectivity to route chirps, using RF channel segmentation to minimize interference and maximize throughput.

3. The method of claim 2, further comprising:
imprinting chirp devices at manufacturing or deployment with cryptographic signatures to ensure zero-trust secure communication;
allowing edge devices to operate autonomously using pre-programmed patterns until dynamically updated by cloud systems.

4. The method of claim 1, wherein low-power edge devices operate as passive relays for nearby chirp transmissions, extending network range without additional power consumption.

5. A scalable and secure chirp messaging protocol for IoT networks, wherein:
chirp messages are cryptic, terse, and self-classifying, enabling receiver-oriented communication with innate security generated by devices at an edge of the IoT network;
propagation through intermediate nodes incorporates tagging and corroboration of chirp data;
dynamic schedules are imposed to manage chirp transmission within intermittent connectivity frameworks, ensuring low-power operation at the edge.

6. A system for dynamically scheduling chirp transmissions in IoT networks, comprising:
at least one orchestrator that assigns dynamic chirp transmission patterns and frequencies to edge devices;
propagator nodes operating as intermediaries to relay chirp messages and manage real-time channel occupancy and interference; and
a mechanism to back-schedule chirp activities from the cloud based on subscriber-driven time windows of relevance and evolving network topology.

7. The system of claim 6, further comprising:
self-healing network properties wherein propagators detect and compensate for edge device failures by rerouting chirp transmissions; and
a mechanism for load balancing and congestion mitigation through dynamic propagator reassignment.

8. The system of claim 6, wherein the cloud orchestrator uses feedback from edge propagators to optimize chirp timing, patterns, and aggregation strategies, adapting to real-time environmental and application needs.

9. The method of claim 1 further comprising:
monitoring energy availability at each network endpoint;
dynamically adjusting energy routing patterns based on historical energy consumption data at the endpoints;
and prioritizing energy allocation to low-power edge devices to ensure sustainability and scalability of the network.

10. The protocol of claim 5, further comprising:
task scheduling based on the energy consumption profiles of participating devices,
routing patterns dynamically adapt to the energy availability of network nodes,
and tasks are distributed to minimize overall energy consumption while ensuring equitable access to resources.

11. The protocol of claim 10, further wherein:
task scheduling includes data concatenation for efficient event-based or scheduled data delivery;
subscription and publication group management within shared information structures;
and energy usage optimization strategies based on historical and real-time consumption data.

12. The system of claim 6, further wherein:
the orchestrator collects and corroborates data from diverse sensor nodes;
the system provides status verification via corroborative multi-sensor analysis; and
the system reduces errors and inefficiencies, such as AI hallucinations, through a distributed network of sensor-equipped agents.

13. The method of claim 1, wherein the orchestration source selects and imprints the chirp pattern.

14. The method of claim 1, wherein a manufacturer of a sensor imprints the chirp pattern.

15. The method of claim 1, wherein a power level for the chirp messages is selected to minimize unauthorized detection.

16. The method of claim 15, wherein the chirp messages comprise terse topic-based addressed short messages.

17. The method of claim 1, wherein the chirp messages are sent by multipurpose sensor patches.

18. The method of claim 1 further comprising an artificial intelligence system to aggregate and filter propagator node output.

19. The method of claim 18, wherein the artificial intelligence system sends control messages to the chirp devices.

20. The method of claim 18, wherein the artificial intelligence system controls energy use by the chirp devices.
